(19) United States
(12) Patent Application Publication
(10) Pub. No.: US 2023/0128996 A1
(43) Pub. Date: Apr. 27, 2023

(54) METHODS AND ARRANGEMENTS FOR ASSOCIATION WITH A NON-COLLOCATED MULTI-LINK DEVICE

(71) Applicant: Intel Corporation, Santa CFlara, CA (US)

(72) Inventors: Laurent Cariou, Milizac (FR); Thomas J. Kenney, Portland, OR (US)

(73) Assignee: Intel Corporation, Santa Clara, CA (US)

(21) Appl. No.: 18/088,346

(22) Filed: Dec. 23, 2022

(51) Int. Cl. H04W 60/04; H04W 12/06

(52) U.S. Cl. CPC H04W 60/04; H04W 12/06

(57) ABSTRACT

Logic to generate and parse a medium access control (MAC) request frame to associate a non-AP MLD with the non-collocated AP MLD, the MAC request frame to comprise an address field, wherein the address field comprises a receiver address (RA) that identifies the first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof. Logic to determine that the MAC request frame is addressed to the non-collocated AP MLD based on the value. And logic to generate a mapping table for a new link ID or transmit the new link ID associated with the non-collocated AP MLD in an association response frame.

### TECHNICAL FIELD

This disclosure generally relates to methods and arrangements for wireless communications and, more particularly, to association of a collocated multi-link device (MLD) with a non-collocated MLD.

### BACKGROUND

The increase in interest in network and Internet connectivity drives design and production of new wireless products. The escalating numbers of wireless devices active as well as the data throughput demands of the users of such devices are increasing demands for access to wireless channels.

In addition to the demands to increase data throughput from increasing numbers of users, the proliferation of mobile wireless devices with high bandwidth and higher data throughput capabilities is also increasing demands for smooth mobility. The Institute of Electrical and Electronics Engineers (IEEE) is developing one or more new standards that utilize Orthogonal Frequency-Division Multiple Access (OFDMA) in channel allocation to increase bandwidth and data throughput capabilities of the devices such as access point stations and non-access point stations, to increase bandwidth and data throughput to meet demands from users. These new standards may require operability with legacy devices and other concurrently developing communications standards.

### BRIEF DESCRIPTION OF THE DRAWINGS

FIG. 1A depicts a system diagram illustrating an embodiment of a network environment for association logic circuitry, in accordance with one or more example embodiments.

FIG. 1B depicts an embodiment illustrating interactions between stations (STAs) of a collated access point (AP) multi-link device (MLD) and a non-collocated AP MLD.

FIG. 1C depicts an embodiment of a system including multiple MLDs.

FIG. 1D illustrates an embodiment of a radio architecture for STAs, such as the wireless interfaces for STAs depicted in FIGS. 1A-C, to implement association logic circuitry.

FIG. 1E illustrates an embodiment of front-end module (FEM) circuitry of a wireless interface for STAs, such as the STAs in FIGS. 1A-C, to implement association logic circuitry.

FIG. 1F illustrates an embodiment of radio integrated circuit (IC) circuitry of a wireless interface for STAs, such as the STAs in FIGS. 1A-C, to implement association logic circuitry.

FIG. 1G illustrates an embodiment of baseband processing circuitry of a wireless interface for STAs, such as the STAs in FIGS. 1A-C, to implement association logic circuitry.

FIG. 2A depicts an embodiment of transmissions between four stations and an AP.

FIG. 2B depicts an embodiment of a transmission between one station and an AP.

FIG. 2C depicts an embodiment of a resource units.

FIG. 2D depicts an embodiment of a multiple user (MU) physical layer (PHY) protocol data unit (PPDU).

FIG. 2E depicts another embodiment of a MU PPDU comprising a data field for a MAC management frame such as the management frame shown in FIG. 2F.

FIG. 2F depicts an embodiment of a physical layer service data unit (PDSU) comprising a MAC management frame such as shown in FIGS. 2G-I.

FIG. 2G depicts an embodiment of frame body elements for an association request frame or a reassociation request frame such as the management frame shown in FIG. 2F.

FIG. 2H depicts an embodiment of frame body elements for an association response frame or reassociation response frame such as the management frame shown in FIG. 2F.

FIG. 2I depicts an embodiment of frame body elements for an authentication frame such as the management frame shown in FIG. 2F.

FIG. 2J depicts an embodiment of a multi-link (ML) element of a MAC management frame such as the management frames shown in FIGS. 2F-2I.

FIG. 2K depicts an embodiment of a common info field of a ML element such as the ML elements shown in FIGS. 2G-2J.

FIG. 2L depicts an embodiment of a link ID info field of a common info field of a ML element such as the common info field in FIG. 2K and the ML elements shown in FIGS. 2G-2J.

FIG. 2M depicts an embodiment of a link info field of a ML element such as the ML elements shown in FIGS. 2G-2J.

FIG. 2N depicts an embodiment of a mapping table to track new link values created by the association logic circuitry of an AP MLD to represent links between a non-AP MLD STA and an AP STA of another AP MLD.

FIG. 2O depicts another embodiment of a physical layer (PHY) frame comprising a data field (or payload) for a MAC management frame such as the frame shown in FIG. 2F.

FIG. 2P depicts the MAC management frame such as the frame shown in FIG. 2F.

FIG. 3 depicts an embodiment of a wireless communications interface with association logic circuitry such as the wireless communications interface shown in FIG. 1C.

FIG. 4A depicts an embodiment of a flowchart to implement association logic circuitry such as the association logic circuitry discussed in conjunction with FIGS. 1-3.

FIG. 4B depicts another embodiment of a flowchart to implement association logic circuitry such as the association logic circuitry discussed in conjunction with FIGS. 1-3.

FIGS. 4C-D depict embodiments of flowcharts to generate and transmit frames and receive and interpret frames for communications between wireless communication devices.

FIG. 5 depicts an embodiment of a functional diagram of a wireless communication device, in accordance with one or more example embodiments of the present disclosure.

FIG. 6 depicts an embodiment of a block diagram of a machine upon which any of one or more techniques may be performed, in accordance with one or more embodiments.

FIGS. 7-8 depict embodiments of a computer-readable storage medium and a computing platform to implement association logic circuitry.

### DETAILED DESCRIPTION OF EMBODIMENTS

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

One of the objectives for Wi-Fi 8 is to allow smooth mobility with zero or low latency and with zero or low packet losses during transitions between access points (APs) in different locations by multi-link (ML) devices (MLDs). The MLDs defined in Institute of Electrical and Electronic Engineers (IEEE) 802.11be D2.2, draft standard October 2022, define protocols for collocated access point (AP) MLDs. To meet the objectives for smooth mobility, embodiments described herein may define novel protocols and operations for authentication and association with a non-collocated AP MLD for Wi-Fi 8, Wi-Fi 9, and/or other wireless communications standards.

Embodiments may comprise association logic circuitry to associate links of more than one STAs of MLDs. Links may be established (or logical) communications channels or connections between MLDs. MLDs include more than one stations (STAs). For instance, an AP MLD and a non-AP MLD may both include STAs configured for multiple frequency bands such as a first STA configured for 2.4 gigahertz (GHz) communications, a second STA configured for 5 GHz communications, and a third STA configured for 6 GHz communications.

In many embodiments discussed herein, MLDs have STAs operating on the same set of carrier frequencies but MLDs are not limited to STAs with any particular set of carrier frequencies. For example, embodiments may comprise MLDs that have a set of STAs operating on one or more overlapping carrier frequencies such as STAs with carrier frequencies in a range of sub 1 GHz, 1 GHz to 7.25 GHz, 7.25 GHz to 45 GHz, above 45 GHz, around 60 GHz, and/or the like.

Note that STAs may be AP STAs or non-AP STAs and may each be associated with a specific link of an MLD. Note also that an MLD can include AP functionality in one or more STAs for one or more links and, if a STA of the MLD operates as an AP on a link, the STA is referred to as an AP STA. If the STA does not perform AP functionality, or does not operate as an AP, on a link, the STA is referred to as a non-AP STA. In many of the embodiments herein, the AP MLDs operate as APs on active links, and the non-AP MLDs operate as non-AP STAs on active links. However, an AP MLD may also have STAs that operate as non-AP STAs on the same extended service set (ESS) or basic service set (BSS) or other ESS's or BSS's.

The concept for a non-collocated MLD is to define operations for an MLD that can have multiple non-collocated, affiliated AP STAs. In many embodiments discussed herein, the non-collocated MLD is organized as non-collocated groups of collocated STAs, wherein each group of STAs is collocated and referred to as a collocated MLD. In many embodiments, each group of collocated STAs may reside in a single housing but embodiments are not limited to collocated STAs being within a single housing. In some embodiments, all AP STAs in an extended service set (ESS) may be affiliated to (or associated with) the same non-collocated AP MLD. The same AP STAs may also be associated with respective collocated AP MLDs.

In an infrastructure BSS, the IEEE 802.1X Authenticator MAC address (AA) and the AP STA's MAC address are the same, and the Supplicant's MAC address (SPA) and the non-AP STA's MAC address are the same. Between an AP MLD and a non-AP MLD, in many embodiments, the IEEE 802.1X Authenticator MAC address (AA) may be set to the MLD MAC address of the AP MLD, and the Supplicant's MAC address (SPA) may be set to the MLD MAC address of the non-AP MLD but embodiments are not limited to such MAC address assignments. Note that the MAC address for a MLD (AP or non-AP) may be the same as a MAC address of one of the STAs of the MLD or may be different from the MAC addresses of all the STAs of the MLD. For instance, if the MLD has three STAs, the MAC address of the MLD may be the same MAC address as, e.g., the first STA of the MLD in some embodiments. In other embodiments, the MAC address of the MLD may be different from all three of the MAC addresses of the STAs of the MLD.

In some embodiments, the MAC address is encoded as 6 octets, taken to represent an unsigned integer. The first octet of the MAC address may be used as the most significant octet. The bit numbering conventions may be used within each octet. In such embodiments, this results in a sequence of 48 bits represented such that bit 0 is the first transmitted bit (Individual/Group bit) and bit 47 is the last transmitted bit. Note that the value of the MAC address included in a field of a MAC frame may comprise the complete MAC address, a compressed or encoded MAC address, a truncated MAC address such as a set of the least significant bits of the MAC address or the last four bits of a MAC address, and/or the like.

Some embodiments may use the same security keys for, e.g., authentication and/or data security, on all APs affiliated to the same non-collocated AP MLD, even if the APs are not collocated. Some embodiments may implement different security keys for, e.g., authentication and/or data security, such that the same security keys are used within a group of collocated AP STAs of a non-collocated AP MLD and different security keys are used between different groups of collocated AP STAs of the non-collocated AP MLD.

Many embodiments describe methods and arrangements for ML association for non-collocated AP MLDs. Some embodiments define a non-collocated MLD, in the presence of IEEE 802.11be STAs that do not support non-collocated MLD operation and protocols. Therefore, every set of collocated AP STAs will then have a dedicated AP MLD and MLDs that do not have capabilities of association and/or authentication with a non-collocated AP MLD may ignore fields of frames or frames that are not decipherable by such MLDs. Each set of collocated AP MLDs may be identified by, e.g., a single MAC address such as the AA or a unique MAC address assigned to the non-collocated AP MLD. This is extendable to many more AP MLDs.

Under an IEEE 802.11be standard protocol, the non-AP MLDs may transition between AP MLD 1 and AP MLD 2 with, e.g., a fast transition (FT) protocol. Furthermore, under the same IEEE 802.11be standard protocol, the non-AP MLDs may not understand if the two AP MLDs have the same AP MLD MAC address such as a MAC address for a non-collocated AP MLD affiliated with AP MLD 1 and AP MLD 2.

To deploy a non-collocated AP MLD 3, embodiments may define a new AP MLD that overlaps with the existing collocated AP MLD 1 and AP MLD 2. In such embodiments, the non-AP MLDs that are capable of supporting non-collocated MLD operation and protocols may associate with the non-collocated AP MLD 3. Furthermore, the non-AP MLDs that do not support non-collocated MLD operation, such as IEEE 802.11be MLDs, may associate separately with AP MLD 1 and/or AP MLD 2.

In many embodiments, an AP STA may be affiliated (associated) with both a collocated AP MLD and a non-collocated AP MLD. For the non-AP MLD to associate with the non-collocated AP MLD, many embodiments use an MLD MAC address of the non-collocated AP MLD or an MLD identifier (ID) of the non-collocated AP MLD (if different from the MLD ID of the collocated AP MLD). Some embodiments may implement a flag to signal an association with the non-collocated AP MLD in an authentication frame and/or an (re)association Request frame.

In some embodiments, the MLD MAC address of the non-collocated AP MLD, the MLD ID, and/or the flag may be included in the core (frame header or MAC header) of a frame such as an authentication frame and/or an (re)association request/response frame, and/or in a field or element of a frame body of the MAC frame. Such embodiments may add one or more new fields called a Recipient MLD MAC Address, Recipient ID, non-collocated, and/or the like, to include the MLD MAC address, MLD ID, and/or flag indicative of a non-collocated AP MLD. In such embodiments, the new field(s) may contain the MLD MAC address of the intended recipient, the MLD ID, and/or the flag (e.g., one or more bits) indicating whether the recipient is the collocated AP MLD or the non-collocated AP MLD.

Note that depending on the discovery procedure implemented, in some embodiments, the non-AP MLD may perform a ML Probe Request to collect the non-collocated MLD information such as the MLD MAC address, the MLD ID, link IDs, STA information, STA profiles, and/or the like.

In some embodiments, the non-AP MLD may identify the links to setup in the ML setup via the link ID info subfield in per-STA profiles in a ML element. Since the link ID advertised in beacons/probes relate to the collocated AP MLD, some embodiments may identify the link by identifying the collocated AP MLD and the link ID of the collocated AP MLD. Such embodiments may identify the collocated AP MLD and the link ID of the collocated AP MLD by inclusion of the MLD MAC address of the collocated AP MLD in an STA MAC address field and the link ID in a STA link ID field. For instance, such embodiments may include in a per-STA profile, the link ID info field (corresponding to the corresponding collocated AP MLD) and include, in same per-STA profile, the MLD ID of the collocated AP MLD and/or the MLD MAC address of the collocated AP MLD.

In some embodiments, the (re)association response frame may be the same as in a regular ML association, except that the AP MLD may assign a new link ID to an AP STA that sets up a link with another AP MLD affiliated with a non-collocated AP MLD. For instance, the AP STA may be identified by a collocated AP MLD with which it is also affiliated and the link ID within the collocated AP MLD. By assigning a new link ID specifically for the non-collocated AP MLD, some embodiments may reuse some of or all the mechanisms (TID-to-link mapping, enhanced ML single radio (EMLSR) operation link enablement, etc.) that use a link bitmap or link ID field and that are bounded to 15 links (while the non-collocated AP MLD may know more than 15 links). The link ID for the non-collocated AP MLD may then be valid only for the associated non-AP MLD and may be different for another non-AP MLD.

In many embodiments, the non-collocated AP MLD link ID may be used for every frame that is unicasted between the non-AP MLD and the non-collocated AP MLD (TID-to-link mapping frames, eMLSR link enablement, etc.). In some embodiments, an AP STA of (affiliated with) a collocated AP MLD and the non-collocated AP MLD may use the link ID of the collocated AP MLD for frames that are sent to the groupcast address (and/or broadcast address) by the AP STA.

In some embodiments, the link ID for the collocated AP MLD and the non-collocated AP MLD may be the same if the MLD association with the non-collocated AP MLD is only done with the AP STAs that are also affiliated with the same collocated AP MLD.

In some embodiments, a non-AP MLD may associate with different AP STAs from multiple collocated AP MLDs that are affiliated with the same non-collocated AP MLD. For instance, a location of a non-AP MLD may be nearest to a first AP MLD but also within range of a second AP MLD that is affiliated with the same non-collocated AP MLD as the first AP MLD. The non-AP MLD may have the strongest signal-to-noise strength from a 2.4 GHz AP STA for a 2.4 GHz link of the first AP MLD but, due to an obstruction, signal interference, or other interference with receipt of transmissions from a 6 GHz AP STA of the first AP MLD, the non-AP MLD may receive the strongest signal-to-noise strength from a 6 GHz AP STA via a 6 GHz link of the second AP MLD. In some embodiments, such circumstances may cause the non-AP STA to associate with the 2.4 GHz AP STA of the first AP MLD and the 6 GHz AP STA of the second AP MLD.

Such embodiments may implement a mapping with, e.g., a mapping table maintained at a collocated AP MLD of the non-collocated AP MLD to associate the link ID of the non-collocated AP MLD with a link ID of the collocated AP MLD combined with the MLD ID, or MLD MAC address of the collocated AP MLD. Further embodiments may setup each link, via association and/or reassociation frames, between the non-AP MLD and the non-collocated AP MLD using the link ID of the non-collocated AP MLD and a link ID of the collocated AP MLD combined with the MLD ID, or MLD MAC address of the collocated AP MLD.

In some embodiments, the mapping table may be defined with the collocated AP MLD field and a non-collocated AP MLD field. The collocated AP MLD field may contain the link ID field with the link ID of the collocated AP MLD and the MLD MAC address or MLD ID field of the collocated AP MLD in addition to the non-collocated AP MLD field containing the link ID field with the link ID of the non-collocated AP MLD.

In some embodiments, a new field called non-collocated link ID field is included in the per-STA profile of the ML element in an association response or a reassociation response. The per-STA profile may have, such as the new fields in the association/reassociation response, a link ID field and a collocated AP MLD MAC Address field to uniquely identify an AP STA of a collocated AP MLD of a non-collocated AP MLD.

Embodiments may comprise association logic circuitry to associate with AP STAs of one or more collocated AP MLDs of a non-collocated AP MLD with links such as a 2.4 GHz link, a 5 GHz link, or a 6 GHz link. Note that while many examples of embodiments discussed herein discuss 2.4 GHz link, a 5 GHz link, or a 6 GHz links, links may have any carrier frequency. Some embodiments may advantageously use of 2.4 GHz links, 5 GHz links, or 6 GHz links due to the proliferation of 2.4 GHz link and 5 GHz link devices as well as the current utility and efficiencies related to the implementation of 6 GHz links. Embodiments discussed herein will be advantageous from an operational and efficiency standpoint regardless of the carrier frequencies.

In some embodiments, the AP MLD may include a 6 GHz AP STA that is also a channel enabler for the 6 GHz channel. In such embodiments, the channel enabler may connect via, e.g., the Internet to an automated frequency coordination (AFC) system and operate under the control of the AFC system to prevent harmful interference to microwave links that operate in the band. The AFC system may determine on which frequencies and at what power levels standard-power devices may operate and may, in some embodiments, be aware of the location of the AP MLD. For instance, in some embodiments, standard power devices may be able to operate on 5.925-6.425 GHz and 6.525-6.875 GHz portions of the 6 GHz channel.

Note that a channel enabler may operate on other frequencies such as 2.4 GHz or 5 GHz to offer more control to a network operator even though such frequencies may not require connection to an AFC system or the like.

For maintaining a quality of service (QoS), many embodiments define two or more access categories. Access categories may be associated with traffic to define priorities (in the form of parameter sets) for access to a channel for transmissions (or communications traffic) such as managed link transmissions. Many embodiments implement an enhanced distributed channel access (EDCA) protocol to establish the priorities. In some embodiments, the EDCA protocol includes access categories such as best efforts (AC_BE), background (AC_BK), video (AC_VI), and voice (AC_VO). Protocols for various standards provide default values for parameter sets for each of the access categories and the values may vary depending upon the type of a STA, the operational role of the STA, and/or the like.

Embodiments may also comprise association logic circuitry to facilitate communications by stations (STAs) in accordance with different versions of Institute of Electrical and Electronics Engineers (IEEE) 802.11 standards for wireless communications (generally referred to as “Wi-Fi”) such as IEEE 802.11-2020, December 2020; IEEE P802.11be™/D2.2, October 2022; IEEE P802.11ax-2021™, IEEE P802.11ay-2021™, IEEE P802.11az™/D3.0, IEEE P802.11ba-2021™, IEEE P802.11bb™/D0.4, IEEE P802.11bc™/D1.02, and IEEE P802.11bd™/D1.1.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

Various embodiments may be designed to address different technical problems associated with association of a non-AP MLD with a non-collocated AP MLD; defining a non-collocated AP MLD; defining links with multiple collocated AP MLDs of a non-collocated AP MLD; backwards compatibility with legacy non-AP MLDs; setup of links for non-collocated AP MLDs; addressing an association request frame, an association response frame, and an authentication frame to a non-collocated AP MLD; mapping links for a non-collocated AP MLD; and/or the like.

Different technical problems such as those discussed above may be addressed by one or more different embodiments. Embodiments may address one or more of these problems associated with association of a non-AP MLD with a non-collocated AP MLD. For instance, some embodiments that address problems associated with association may do so by one or more different technical means, such as, parsing a medium access control (MAC) request frame to associate a non-AP MLD with the non-collocated AP MLD, the MAC request frame to comprise a recipient MLD MAC address field comprising a MAC address to identify the non-collocated AP MLD, a recipient identifier (ID) field comprising a value to identify the non-collocated AP MLD, a non-collocation ID field comprising a value of a flag to indicate whether the MAC frame is addressed to the non-collocated AP MLD or is addressed to the first AP MLD, or a combination thereof, wherein the first AP MLD is a collocated AP MLD; determining that the MAC request frame is addressed to the non-collocated AP MLD or the first AP MLD; generating a MAC response frame comprising an address field comprising the MAC address to identify the non-collocated AP MLD; a MLD ID field comprising the value to identify the non-collocated AP MLD; a non-collocation ID field comprising the value of the flag to indicate whether the MAC frame is addressed from the non-collocated AP MLD or is addressed from the first AP MLD; or a combination thereof, causing transmission of the MAC response frame to the non-AP MLD; using, for authentication, the same security keys for different groups of collocated AP STAs of a non-collocated AP MLD, wherein the different groups of collocated AP STAs are non-collocated; using, for authentication, different security keys for different groups of collocated AP STAs of a non-collocated AP MLD, wherein the different groups of collocated AP STAs are non-collocated; determining a value of a recipient MLD MAC address field for the non-collocated AP MLD ID, wherein the value of the recipient MLD MAC address field comprises an authenticator address; determining the value of the flag, wherein the value of the flag comprises one or more bits, the value to indicate whether the MAC frame is addressed to the non-collocated AP MLD or addressed to the first AP MLD, wherein the first AP MLD is a collocated AP MLD; generate a medium access control (MAC) request frame, the MAC request frame to comprise a recipient MLD MAC address field comprising a MAC address to identify the non-collocated AP MLD, a recipient identifier (ID) field comprising a value to identify the non-collocated AP MLD, a non-collocation ID field comprising a value of a flag to indicate whether the MAC frame is addressed to the non-collocated AP MLD or is addressed to the first AP MLD, or a combination thereof, wherein the first AP MLD is a collocated AP MLD; causing transmission of the MAC request frame to the non-AP MLD; receiving a MAC response frame to confirm or reject the association with the non-collated AP MLD, the mac response frame comprising an address field comprising the MAC address to identify the non-collocated AP MLD; a MLD ID field comprising the value to identify the non-collocated AP MLD; a non-collocation ID field comprising the value of the flag to indicate whether the MAC frame is addressed from the non-collocated AP MLD or is addressed from the first AP MLD; or a combination thereof, determining, for generation of the MAC response frame, a value of a recipient MLD MAC address field for the non-collocated AP MLD ID, wherein the value of the recipient MLD MAC address field comprises an authenticator address; determining, for generation of the MAC request frame, the value of the flag, wherein the value of the flag comprises one or more bits, the value to indicate whether the MAC frame is addressed to the non-collocated AP MLD or addressed to the first AP MLD, wherein the first AP MLD is a collocated AP MLD; determining, for generation of the frame header, the value for the non-collocated AP MLD ID, the value of the flag, or a combination thereof, and determining, for generation of a ML element in the frame body, the value for the non-collocated AP MLD ID, the value of the flag, or a combination thereof; and/or the like.

Several embodiments comprise central servers, access points (APs), and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, and the like), and the like.

Some embodiments may facilitate wireless communications in accordance with multiple standards. Some embodiments may comprise low power wireless communications like Bluetooth®, cellular communications, and messaging systems. Furthermore, some wireless embodiments may incorporate a single antenna while other embodiments may employ multiple antennas or antenna elements.

While some of the specific embodiments described below will reference the embodiments with specific configurations, those of skill in the art will realize that embodiments of the present disclosure may advantageously be implemented with other configurations with similar issues or problems.

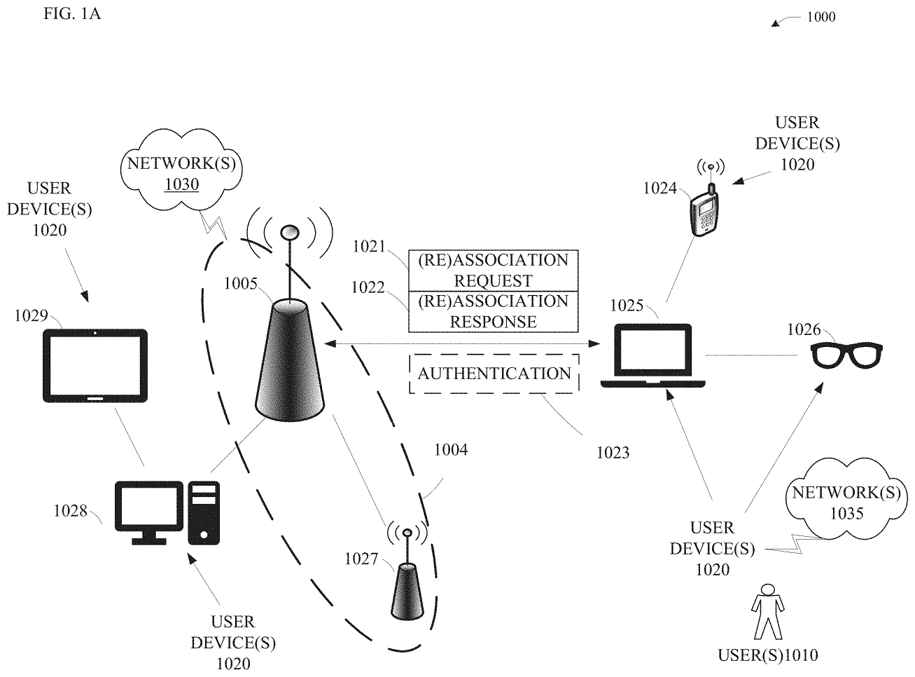

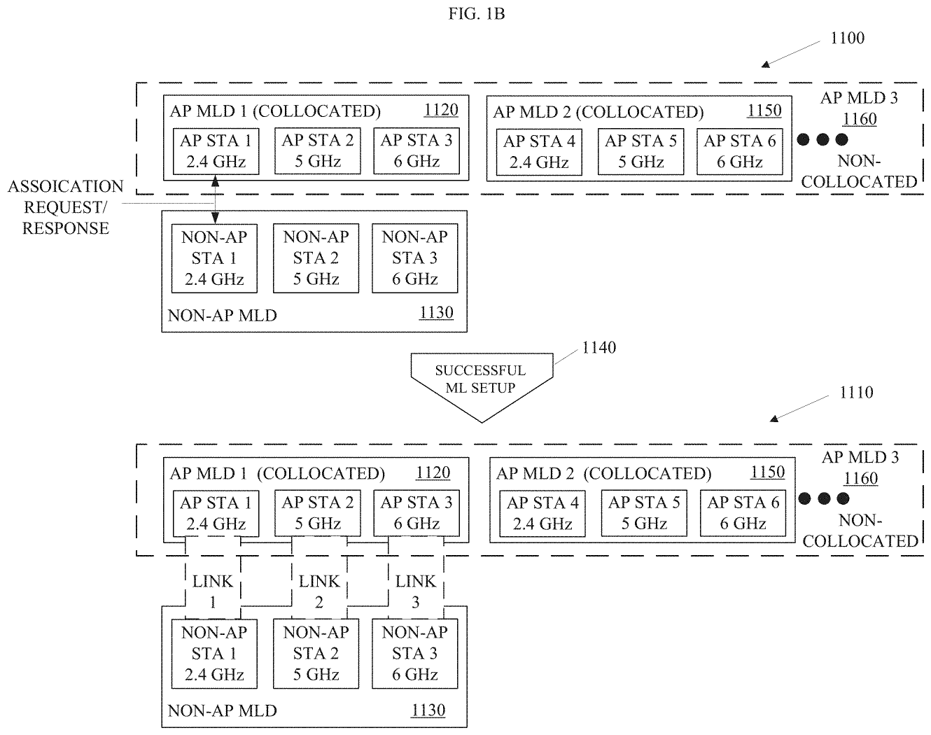

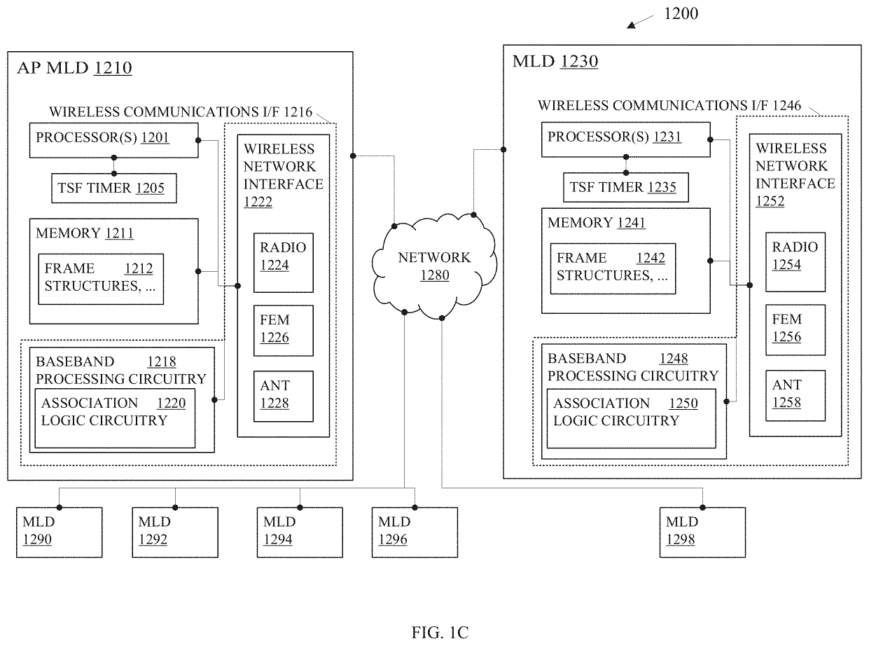

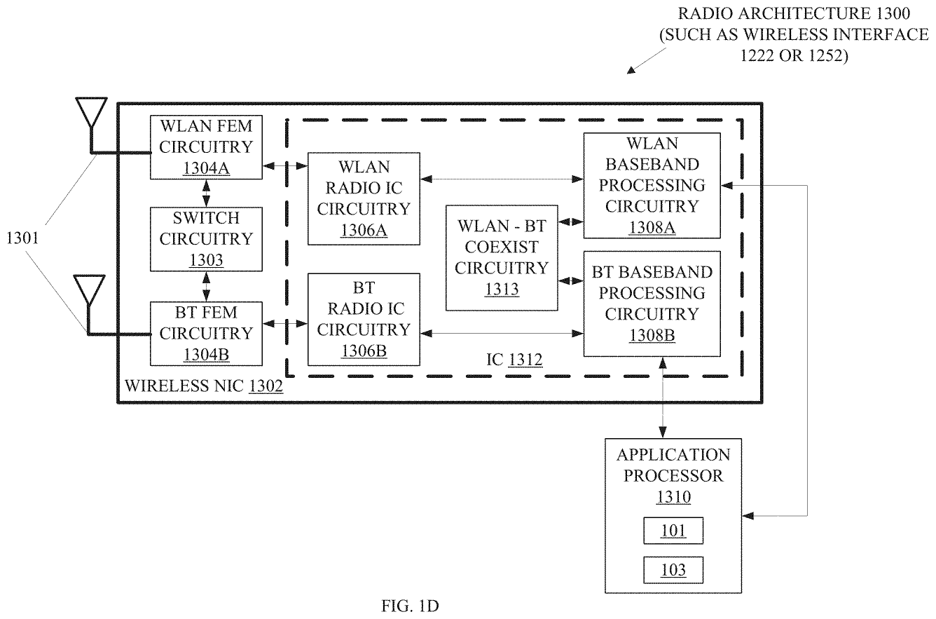

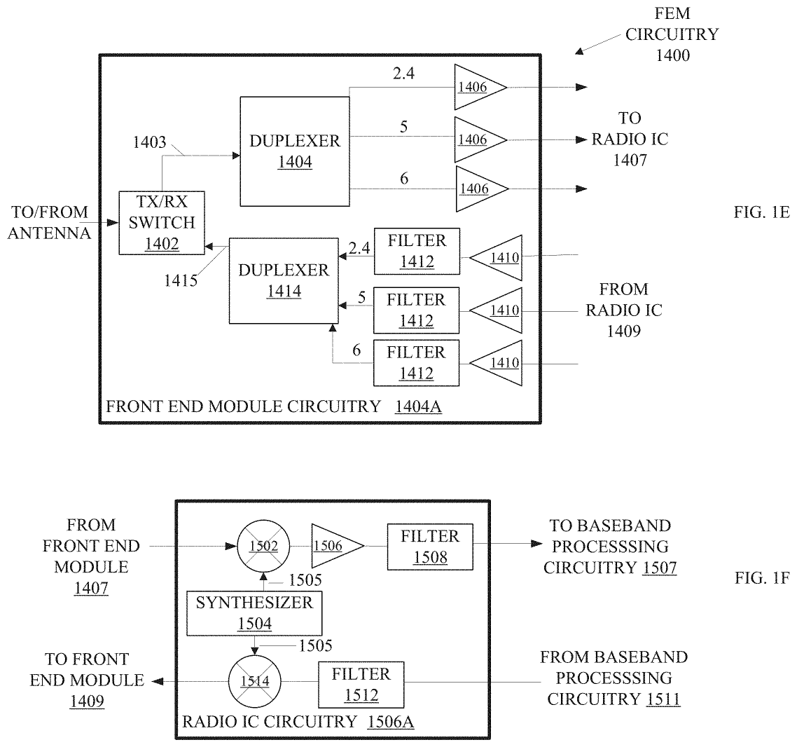

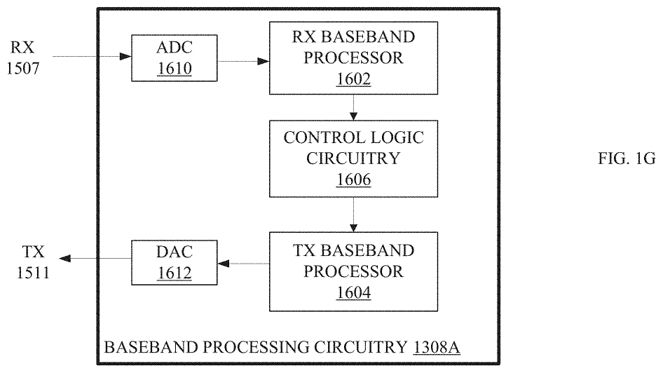

FIG. 1A depicts a system diagram illustrating an embodiment of a network environment for association logic circuitry, in accordance with one or more example embodiments. Wireless network 1000 may include one or more access point (AP) multi-link devices (AP-MLDs) 1005 and 1027, and one or more user devices 1020 (non-AP MLDs), which may communicate in accordance with IEEE 802.11 communication standards.

In the present embodiment, the AP MLD 1005 may comprise a collocated set of AP stations (STAs) and the AP MLD 1027 may comprise a collocated set of AP STAs. Furthermore, the AP MLD 1005 and AP MLD 1027 may be affiliated with the same basic service set (BSS) and may be affiliated with a non-collocated AP MLD 1004. The non-collocated AP MLD 1004 may comprise a logical non-collocated AP MLD supported by association logic circuitry in the non-AP MLDs and the AP MLDs to allow STAs such as the user device(s) 1020 to form links with the AP STAs of one or both the AP MLD 1005 and AP MLD 1027 via one collocated AP MLD and to quickly transition between the AP MLD 1005 and AP MLD 1027 based on, e.g., signal strengths of the corresponding AP STAs, as the user device(s) 1020 move about the network environment or as conditions of the environment change.

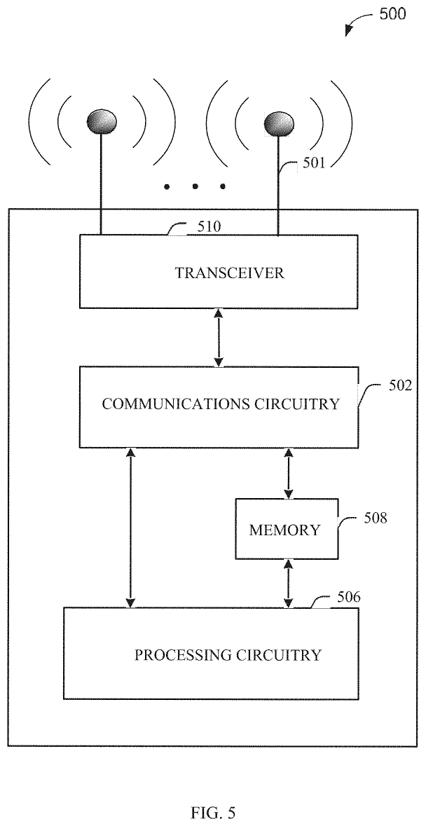

The user device(s) 1020 may comprise mobile devices that are non-stationary (e.g., not having fixed locations) and/or stationary devices. In some embodiments, the user device(s) 1020 and the AP-MLDs 1005 and 1027 may include one or more computer systems similar to the STAs shown in FIGS. 1B-1G and/or the example machine/system of FIGS. 5, 6, 7, and 8.

One or more illustrative user device(s) 1020 and/or AP-MLDs 1005 and 1027 may be operable by one or more user(s) 1010. It should be noted that any addressable unit may be a station (STA). A STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 1020 and the AP-MLDs 1005 and 1027 may include STAs. The one or more illustrative user device(s) 1020 and/or AP-MLDs 1005 and 1027 may operate as an extended service set (ESS), a basic service set (BSS), a personal basic service set (PBSS), or a control point/access point (PCP/AP). The user device(s) 1020 (e.g., 1024, 1025, 1026, 1028, or 1029) and/or AP-MLDs 1005 and 1027 may include any suitable processor-driven device including, but not limited to, a mobile device or a non-mobile, e.g., a static device. For example, user device(s) 1020 and/or AP-MLDs 1005 and 1027 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless network interface, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

In some embodiments, the user device(s) 1020 and/or AP-MLDs 1005 and 1027 may also include mesh stations in, for example, a mesh network, in accordance with one or more IEEE 802.11 standards and/or 3GPP standards.

Any of the user device(s) 1020 (e.g., user devices 1024, 1025, 1026, 1028, and 1029) and AP-MLDs 1005 and 1027 may be configured to communicate with each other via one or more communications networks 1030 and/or 1035 wirelessly or wired. In some embodiments, the user device(s) 1020 may also communicate peer-to-peer or directly with each other with or without the AP-MLDs 1005 and 1027 and, in some embodiments, the user device(s) 1020 may also communicate peer-to-peer if enabled by the AP-MLDs 1005 and 1027.

Furthermore, the AP-MLDs 1005 and 1027 may each comprise association logic circuitry to implement association authentication and link setup protocols, procedures, frames, mapping, and/or the like as discussed herein to implement a non-collocated AP MLD 1004. In the present embodiment, the AP-MLDs 1005 and 1027 may comprise 2.4 GHz, 5 GHz, and 6 GHz STAs. Note that embodiments are not limited to STAs capable of any particular set of carrier frequencies and the STAs of AP MLDs that are part of the non-collocated AP MLD 1004 are not required to have sets of STAs with the same carrier frequencies. Note also that the non-collocated AP MLD 1004 is not limited to inclusion of two AP MLDs. The non-collocated AP MLD 1004 may include more than two AP MLDs or may include all AP MLDs in a BSS or ESS.

The association logic circuitry of the AP-MLDs 1005 and 1027 may implement authentication and/or association protocols to enable authentication and association of a non-AP MLD with the non-collocated AP MLD 1004 as well as with the AP MLDs 1005 and 1027. In the present embodiment, a collocated non-AP MLD, laptop 1025, may determine to associate with the non-collocated AP MLD 1004 via the AP MLD 1005 via wireless communications media such as a 2.4 GHz link via a 2.4 GHz channel, a 5 GHz link via a 5 GHz channel, and a 6 GHz link via a 6 GHz channel. In some embodiments, the association logic circuitry of a multiple medium access control (MAC) station management entity (SME) (MM-SME) and one or more STA SMEs of the laptop 1025 may determine field values for and cause transmission of a MAC authentication frame 1025 via a physical layer (PHY) frame to the AP MLD 1005. The MM-SME may be a component of station management of a MLD (such as non-AP MLDs and AP MLDs) that manages multiple cooperating, collocated STAs of the MLD. In other embodiments, transmission of the MAC authentication frame is optional or unnecessary to initiate an association procedure between non-AP STAs of the laptop 1025 and AP STAs of the AP MLD 1005 as part of the non-collocated AP MLD 1004.

Two services are required for IEEE Std 802.11 to provide functionality equivalent to that which is inherent to wired local access networks (LANs). The design of wired LANs assumes the physical attributes of wire. In particular, wired LAN design assumes the physically closed and controlled nature of wired media. The physically open medium nature of an IEEE 802.11 LAN violates those assumptions.

In a WLAN that does not support robust security network association (RSNA), two services, authentication and data confidentiality, are defined. IEEE 802.11 authentication is used instead of the wired media physical connection. Wired equivalent privacy (WEP) encryption was defined to provide the data confidentiality aspects of closed wired media. An RSNA uses the IEEE 802.1X authentication service along with enhanced data cryptographic encapsulation mechanisms, such as temporal key integrity protocol (TKIP), cipher-block chaining message authentication code (CBC-MAC) protocol (CCMP), and Galois/counter mode (GCM) protocol (GCMP), to provide access control. The IEEE 802.11 station management entity (SME) provides key management via an exchange of Extensible Authentication Protocol over LANs (EAPOL)-Key frames. Data confidentiality and data integrity are provided by RSN key management together with the enhanced data cryptographic encapsulation mechanisms.

IEEE 802.11 authentication operates at the link level between IEEE 802.11 STAs such as the STAs of the AP MLDs 1005 and 1027 and the STAs of user device(s) 1020 such as the laptop 1025. IEEE Std 802.11 defines five IEEE 802.11 authentication methods: Open System authentication, Shared Key authentication, fast BSS transition (FT) authentication, simultaneous authentication of equals (SAE), and fast link setup (FILS) authentication.

The association logic circuitry of the laptop 1025 may determine to transmit the MAC authentication frame for SAE authentication prior to association to establish the identity of one or more STAs of the laptop 1025 prior to association. In other embodiments, the association logic circuitry of the laptop 1025 may determine to transmit the MAC authentication frame to initiate FT or as part of a FILS procedure. Note that collocated AP MLDs affiliated with the same non-collocated AP MLD may use the same security keys for authentication and/or data security or each collocated AP MLD may use a different set of security keys for authentication and/or data security.

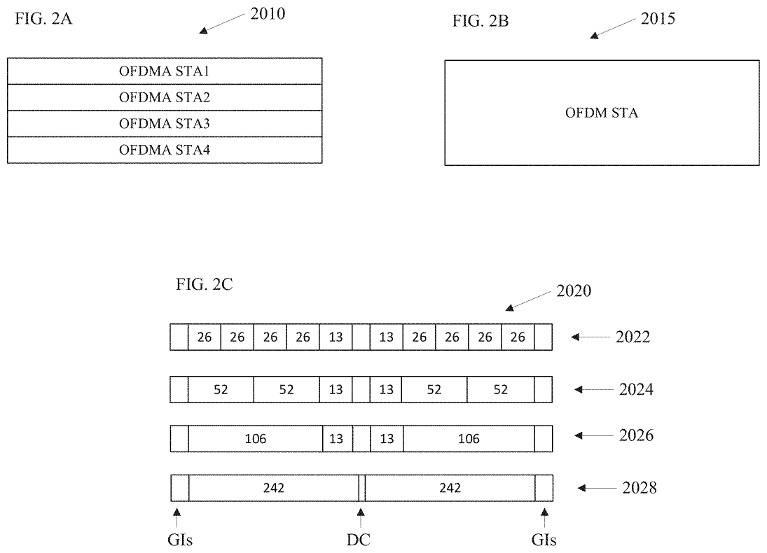

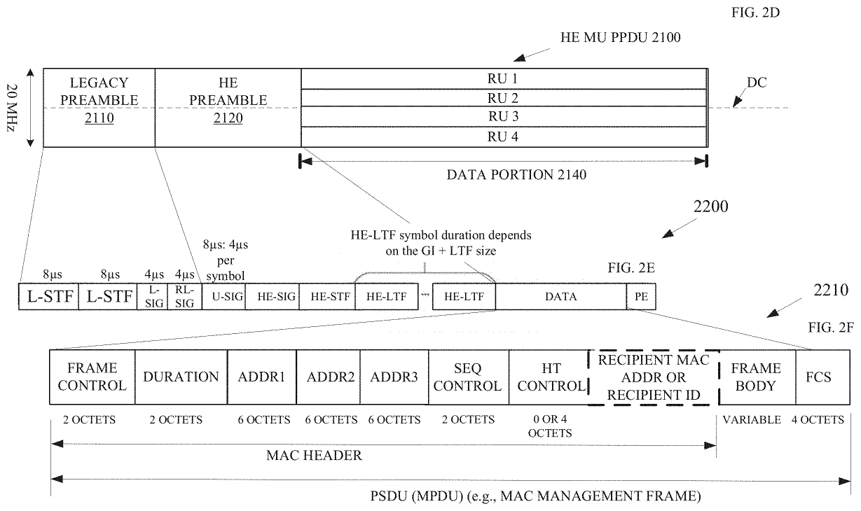

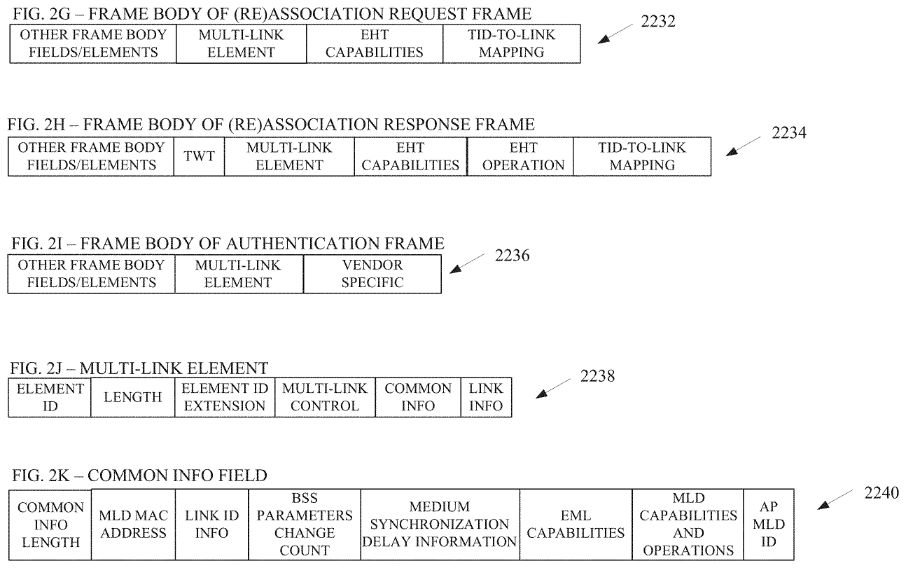

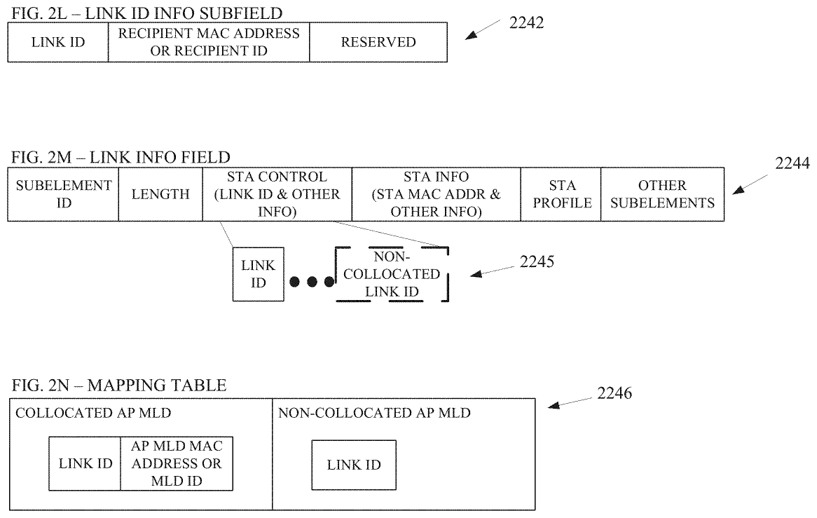

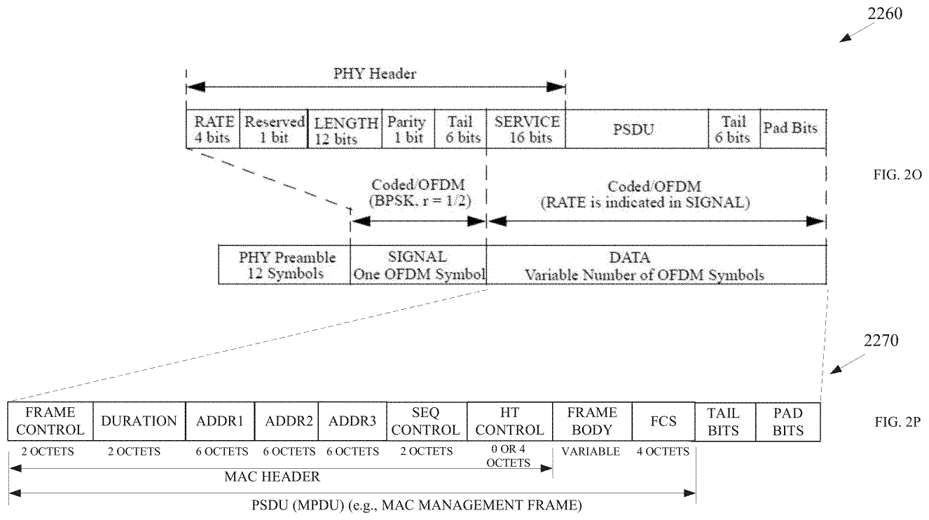

The authentication frame 1023 may be a MAC management frame and may comprise fields such as the MAC management frames shown in FIGS. 2F, 2I, and 2Q. The association logic circuitry of the laptop 1025 may comprise information about the AP MLD 1005 and the non-collocated AP MLD 2004 based on receipt of a beacon frame, a probe response frame, one or more other discovery and/or advertisement frames, and/or the like. The association logic circuitry of the laptop 1025 may determine a value of a field to identify the non-collocated AP MLD 1004 as a recipient of the authentication frame 1023 in addition to an address field to identify a collocated AP MLD via a recipient address (RA). In some embodiments, the association logic circuitry of the laptop 1025 may determine the value as a MAC address for the non-collocated AP MLD 1004. In some embodiments, the association logic circuitry of the laptop 1025 may determine the value as a MAC ID for the non-collocated AP MLD 1004. In some embodiments, the association logic circuitry of the laptop 1025 may determine the value of a flag indicative of the non-collocated AP MLD 1004 being the recipient rather than the AP MLD 1005 to which the authentication frame 1023 is also addressed with the RA. In some embodiments, the association logic circuitry of the laptop 1025 may determine more than one or all the values for the MAC address, MAC ID, and the flag for inclusion in the authentication frame 1023.

In some embodiments, the association logic circuitry of the laptop 1025 may generate the authentication frame 1023 with a new field in the core of the authentication frame such as a recipient MAC address field or a recipient ID field and include the value of the MAC address, the MAC ID, and/or the flag in the recipient MAC address field or the recipient ID field. In some embodiments, the association logic circuitry may generate a new field referred to as a non-collocated field for inclusion of the value of the flag. The flag may comprise one bit to indicate whether the authentication frame is transmitted to the AP MLD 1005 or the non-collocated AP MLD 1004. For instance, the value of the one bit may be set to a logical one to indicate that the authentication frame is addressed for the non-collocated AP MLD 1004, set to a logical zero to indicate that the authentication frame is addressed for the AP MLD 1005, or vice versa. In other embodiments, the flag may include more than one bit such as two bits, three bits, four bits, or more bits to include the value of the flag and, optionally, other information.

In many embodiments, the recipient MAC address field, the recipient ID field, or the non-collocated field may be included in the frame header of the authentication frame 1023. In some of such embodiments, the MAC address field, the recipient ID field, or the non-collocated field may be included in the frame control field of the frame header of the authentication frame 1023. In other embodiments, the recipient MAC address field, the recipient ID field, or the non-collocated field may be included in the frame body of the authentication frame 1023 such as a field included in the frame body or in an element included in the frame body. In some embodiments, the recipient MAC address field, the recipient ID field, or the non-collocated field may be included in a common info field of a ML element of the frame body of the authentication frame 1023. Note that a reassociation and an association request frame may also be addressed in the same way as the authentication frame via an address field for an RA and a new field with a MAC address, MLD ID, and/or a flag to identify the non-collocated AP MLD 1004 in the frame header or the frame body of the reassociation and association request frames (also referred to as (re)association request frames).

In addition to or in lieu of transmission of the authentication frame 1023, the association logic circuitry of the laptop 1025 may include the MAC address for the AP MLD 1004, the MLD ID for the AP MLD 1004, and/or the flag for the non-collocated AP MLD 1004 in the frame header or frame body of an association request frame 1022 to the AP MLD 1005. The inclusion of the MAC address, MLD ID, and/or the flag may indicate to the AP MLD 1005 that the association request frame 1022 is addressed to the non-collocated AP MLD 1004.

Similar to the authentication frame 1023, the recipient MAC address field, the recipient ID field, or the non-collocated field may be included in the frame header of the association request frame 1023 or the frame body of the association request frame 1021 with the value of the MAC Address, MLD ID, and/or flag indicative of the non-collocated AP MLD 1004. In some of such embodiments, the MAC address field, the recipient ID field, or the non-collocated field may be included in the frame control field of the frame header of the association request frame 1021. In other embodiments, the recipient MAC address field, the recipient ID field, or the non-collocated field may be included in the frame body of the association request frame 1021 such as a field included in the frame body or in an element included in the frame body. In some embodiments, the recipient MAC address field, the recipient ID field, or the non-collocated field may be included in a common info field of a ML element of the frame body of the association request frame 1021.

The association logic circuitry of the laptop 1025 (non-AP MLD) may initiate the ML setup procedure and non-AP STA 1 affiliated with the non-AP MLD (laptop 1025) may send an association request frame 1022 to AP STA 1 affiliated with the AP MLD 1005 with the transmitter address (TA) field (address 2) of the association request frame 1021 set to the MAC address of the non-AP STA 1 and the receiver address (RA) field (address 1) of the association request frame set to the MAC address of the AP STA 1. The association request frame may include a basic ML element that indicates the MLD MAC address of the non-AP MLD (laptop 1025) and complete profile of non-AP STA 1 of the laptop 1025 (in the frame body of the association request frame), non-AP STA 2 (in a Per-STA Profile subelement carried in the basic ML element), and non-AP STA 3 (in a Per-STA Profile subelement carried in the basic ML element) to request three links to be setup (one link between AP STA 1 and non-AP STA 1, one link between AP STA 2 and non-AP STA 2, and one link between AP STA 3 and non-AP STA 3).

The association logic circuitry of the laptop 1025 may also generate one or more Per-STA subelements in the link info field of the ML element in the frame body of the association request frame 1021 to negotiate links to logically connect one or more of the non-AP STAs of the laptop 1025 with one or more of the AP STAs of the non-collocated AP MLD 1004. Note that the AP STAs of the non-collocated AP MLD 1004 may comprise AP STAs of the AP MLD 1005, AP STAs of the AP MLD 1027, and possibility AP STAs of other AP MLDs affiliated with the non-collocated AP MLD 1004.

In some embodiments, the considerations for selecting the AP MLD 1005 for associating with the non-collocated AP MLD 1004 by the association logic circuitry of the laptop 1025 may also cause the laptop 1025 to set up linked for all the non-AP STAs of the laptop 1025 with the AP STAs of the AP MLD 1005. In other embodiments, the laptop 1025 may set up links non-AP STAs of the laptop 1025 with one or more AP STAs of the AP MLD 1005 and/or with one or more non-AP STAs of the, e.g., AP MLD 1027 of the non-collocated AP MLD 1004.

In some embodiments, the association logic circuitry of the laptop 1025 may generate the association request frame 1021 comprising a basic ML element that carries the complete profile of non-AP STA 1 in the frame body of the association request frame 1021 and the complete profile of, e.g., two other non-AP STAs of the laptop 1025, e.g., non-AP STA 2 and non-AP STA 3 in the per-STA profile subelements of the link info field of the ML element in the frame body of the association request frame 1021. The Type subfield of the ML control field is set to 0 to indicate that the ML element is a basic ML element. the common info field carries information that applies to the MLD level. Each per-STA profile subelement in the link info field carries the complete profile, with inheritance applied, of a reported non-AP STA affiliated with the laptop 1025. Each per-STA profile subelement carries the STA control field followed by the STA info field and the STA profile field. The STA profile field carries variable number of fields and elements in order with inheritance applied. A non-inheritance element (if present) lists the elements that are not inherited by the reported STA.

In many embodiments, in addition to identifying the complete profile of the non-AP STAs of the laptop 1025, the association logic circuitry of the laptop 1025 may also generate per-STA profile subelements to identify the links to be set up for the non-collocated AP MLD 1004. Each per-STA profile subelement includes a link ID field in the STA control field and a STA MAC address field in the STA info field. For non-AP STAs 2 and 3 discussed above, these fields include the link ID and MAC address of the non-AP STA 2 and 3 of laptop 1025. To identify the links 1, 2, and 3 to setup for the non-AP STAs 1, 2, and 3, respectively, with the non-collocated AP MLD 1004, the association logic circuitry of the laptop 1025 may generate a per-STA profile subelement for each of the links 1, 2, and 3 that includes an AP STA link ID and an AP STA MAC address. For instance, to setup link 1 for non-AP STA 1, the association logic circuitry of the laptop 1025 may identify a link ID and MAC address for an AP STA of the AP MLD 1005 or of the AP MLD 1027. For link 1, for example, the association logic circuitry may generate a per-STA profile subelement that comprises a link ID field in the STA control field with a link ID for AP STA 1 of the AP MLD 1005 and a STA MAC address field in the STA info field with a MAC address for AP STA 1 of the AP MLD 1005. The association logic circuitry may generate a per-STA profile subelement that comprises a link ID field in the STA control field with a link ID for AP STA 2 of the AP MLD 1027 and a STA MAC address field in the STA info field with a MAC address for AP STA 2 of the AP MLD 1027. And the association logic circuitry may generate a per-STA profile subelement that comprises a link ID field in the STA control field with a link ID for AP STA 3 of the AP MLD 1005 and a STA MAC address field in the STA info field with the MAC address for AP STA 3 of the AP MLD 1005. In other words, the per-STA profile subelement to identify the AP STA to link with the non-AP STA 1 of the laptop 1025 may include the link ID for AP STA 1 of AP MLD 1005 and the MAC address of AP STA 1 of AP MLD 1005. The per-STA profile subelement to identify the AP STA to link with the non-AP STA 2 of the laptop 1025 may include the link ID for AP STA 2 of AP MLD 1027 and the MAC address of AP STA 2 of AP MLD 1027. And the per-STA profile subelement to identify the AP STA to link with the non-AP STA 3 of the laptop 1025 may include the link ID for AP STA 3 of AP MLD 1005 and the MAC address of AP STA 3 of AP MLD 1005.

Note that the example includes AP STAs for both AP MLDs 1005 and 1027 of the non-collocated AP MLD 1004 but embodiments are not so limited. The per-STA profile subelements can identify any AP STA of any AP MLD that is associated with the non-collocated AP MLD 1004 that has matching operating capabilities and parameters such as the same carrier frequencies, modulation and coding capabilities, operating parameters, and/or the like. Furthermore, the laptop 1025 may associate all links with the same AP MLD of the non-collocation AP MLD 1004 such as AP MLD 1005.

The association logic circuitry of the AP MLD 1005 may respond to the requested ML setup in the association request frame 1021 from the non-AP STA 1 of the laptop 1025, and AP STA 1 affiliated with the AP MLD 1005 may send an association response frame 1022 to non-AP STA 1 affiliated with the laptop 1025 (non-AP MLD) with the TA field (or address 2 field) of the association response frame 1022 set to the MAC address of the AP STA 1 (or the MAC address of AP MLD 1005) and the RA field (or address 1 field) of the association response frame 1022 set to the MAC address of the non-AP STA 1 (or the MAC address of the non-AP MLD or laptop 1025), to indicate successful ML setup. In some embodiments, the association response frame 1022 may alternatively indicate a failure and not set up the links.

For situations in which the laptop 1025 requested that all non-AP STAs of the laptop 1025 be linked with AP STAs of the AP MLD 1005 of the non-collocated AP MLD 1004, the association response frame 1022 may include a basic ML element that indicates the MLD MAC address of the AP MLD 1005 and complete profile of AP STA 1 (in the frame body of the association response frame 1022), AP STA 2 (in a Per-STA Profile subelement carried in the basic ML element), and AP STA 3 (in a Per-STA Profile subelement carried in the basic ML element). After successful ML setup between the laptop 1025 and the AP MLD 1005 of the non-collocated AP MLD 1004, three links are setup (link 1 between AP STA 1 and non-AP STA 1, link 2 between AP STA 2 and non-AP STA 2, and link 3 between AP STA 3 and non-AP STA 3).

For situations in which the link is between the non-AP STA of the laptop 1025 and the AP STA of the AP MLD 1027 of the non-collocation AP MLD 1004, the value of the link ID in the link ID field of the STA control field of the link info field of the ML element of the association response frame 1022 may be a new value determined by the association logic circuitry of the AP MLD 1005. The new value may be a logical representation of the value for the link ID of the link established between the non-AP-STA of the laptop 1025 and the AP STA of the AP MLD 1027. The new link value may advantageously be treated as a link ID of the AP MLD 1005 by the association logic circuitry of the AP MLD 1005, and advantageously allow the MM-SME and AP STA SME of the AP MLD 1005 to perform other services such as TID-to-link mapping frames, eMSL link enablement, and/or the like, with the new value for the link ID.

In some embodiments, the new value for the link ID may only be used by the laptop 1025 and the AP MLD 1005 for unicast communications between the laptop 1025 and the AP MLD 1005. In some embodiments, the association logic circuitry of the AP MLD 1005 may advantageously track new link ID values determined to represent links between the laptop 1025 and another AP MLD such as AP MLD 1027 by creating new mapping table entries for a mapping table. The new mapping table may include a collocated AP MLD field and a non-collocated AP MLD field for each mapping table entry. The collocated AP MLD field may comprise a link ID field and a MAC address field or a MLD ID field. For the AP MLD 1005, the link ID field may include the link ID of the link between the non-AP STA of the laptop 1025 and the AP STA of the AP MLD 1027. The AP MLD MAC address of the collocated AP MLD field may include the MAC address of the AP STA of the AP MLD 1027 associated with the link value in the link ID field of the collocated AP MLD field. The link ID field of the non-collocated AP MLD may include the new value determined to represent the link in the link value in the link ID field of the collocated AP MLD field between the non-AP STA of the laptop 1025 and the AP MLD 1027.

In other embodiments, rather than generating new mapping table entries to track new link values determined by the association logic circuitry of the AP MLD 1005 for links between a non-AP STA and an AP STA of another AP MLD of the collocated AP MLD 1004, the association logic circuitry of the AP MLD 1005 may include a new field, a non-collocation link ID field, in the STA control field of the link info field of the ML element of the (re)association response frame 1022. In such embodiments, the AP MLD 1005 may determine a new value for the link ID for the non-collocated AP MLD 1004 (for unicast use between the AP MLD 1005 and the laptop 1025) and include the new value of the link ID for the non-collocated AP MLD 1004 in the non-collocation link ID field.

For example, if the link is between the non-AP STA of the laptop 1025 and the AP STA of the AP MLD 1027 of the non-collocation AP MLD 1004, the association logic circuitry may create the new value for the link ID in the non-collocation link ID field and may include the new value in the non-collocation link ID field of the STA control field of the link info field of the ML element of the association response frame 1022. The new value may be a logical representation of the link value for the link between the non-AP-STA of the laptop 1025 and the AP STA of the AP MLD 1027 that can, advantageously be treated as a link ID of the AP MLD 1005 by the association logic circuitry of the AP MLD 1005. In such embodiments, the MM-SME and AP STA SME of the AP MLD 1005 may perform other services such as TID-to-link mapping frames, eMSL link enablement, and/or the like, with the new value for the link ID for the link between the non-AP-STA of the laptop 1025 and the AP STA of the AP MLD 1027.

Any of the communications networks 1030 and/or 1035 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 1030 and/or 1035 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 1030 and/or 1035 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 1020 (e.g., user devices 1024, 1025, 1026, 1028, and 1029), the AP MLD 1005, and the AP-MLD 1027 may include one or more communications antennas. The one or more communications antennas may be any suitable type of antennas corresponding to the communications protocols used by the user device(s) 1020 (e.g., user devices 1024, 1025, 1026, 1028, and 1029) and AP-MLD 1005. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 1020, AP MLD 1005, and/or AP-MLD 1027.

Any of the user device(s) 1020 (e.g., user devices 1024, 1025, 1026, 1028, and 1029), the AP MLD 1005, and AP-MLD 1027 may be configured to wirelessly communicate in a wireless network. Any of the user device(s) 1020 (e.g., user devices 1024, 1025, 1026, 1028, and 1029), the AP MLD 1005, and AP-MLD 1027 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 1020 (e.g., user devices 1024, 1025, 1026, 1028, and 1029), the AP MLD 1005, and AP-HLD 1027 may be configured to perform any given directional transmission towards one or more defined transmit sectors. Any of the user device(s) 1020 (e.g., user devices 1024, 1025, 1026, 1028, and 1029), the AP MLD 1005, and AP-MLD 1027 may be configured to perform any given directional reception from one or more defined receive sectors.

MIMO beamforming in a wireless network may be accomplished using RF beamforming and/or digital beamforming. In some embodiments, in performing a given MIMO transmission, user devices 1020, AP MLD 1005, and/or AP-MLD 1027 may be configured to use all or a subset of its one or more communications antennas to perform MIMO beamforming.

Any of the user devices 1020 (e.g., user devices 1024, 1025, 1026, 1028, and 1029), the AP MLD 1005, and AP-MLD 1027 may include any suitable radio and/or transceiver for transmitting and/or receiving radio frequency (RF) signals in the bandwidth and/or channels corresponding to the communications protocols utilized by any of the user device(s) 1020 and AP-MLD 1005 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g., 802.11b, 802.11g, 802.11n, 802.11ax, 802.11be), 5 GHz channels (e.g., 802.11n, 802.11ac, 802.11ax, 802.11be), 6 GHz (e.g., 802.11be), or 60 GHz channels (e.g., 802.11ad, 802.11ay, Next Generation Wi-Fi) or 800 MHz channels (e.g., 802.11ah). The communications antennas may operate at 28 GHz, 40 GHz, or any carrier frequency between 45 GHz and 75 GHz. It should be understood that this list of communication channels in accordance with certain 802.11 standards is only a partial list, and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g., IEEE 802.11af, IEEE 802.22), white band frequency (e.g., white spaces), or other packetized radio communications. The radio component may include any known receiver and baseband suitable for communicating via the communications protocols. The radio component may further include a power amplifier (PA), a low noise amplifier (LNA), additional signal amplifiers, an analog-to-digital (A/D) converter, one or more buffers, and a digital baseband.

FIG. 1B depicts an embodiment 1100 illustrating interactions between stations (STAs) to establish multiple links between an access point (AP) ML device (MLD) 1120 and a non-AP MLD 1130. The AP MLD 1120 has three collocated affiliated AP STAs: AP STA 1 operates on 2.4 GHz band, AP STA 2 operates on 5 GHz band, and AP STA 3 operates on 6 GHz band. The AP MLD 1120 is also affiliated with a non-collocated AP MLD 1160 and a collocated AP MLD 1150 that is also affiliated with the non-collocated AP MLD 1160. The pre-association state 1100 depicts the non-AP MLD 1120 and the non-collocated AP MLD 1160 without links. The post-association state 1110 depicts the non-AP MLD 1120 and the non-collocated AP MLD 1160 with links set up.

The non-AP STA 1 affiliated with the non-AP MLD 1130 sends an association request frame (or a reassociation request frame) to AP STA 1 affiliated with the AP MLD 1120 and with the non-collocated AP MLD 1160. The association request frame may have a TA field set to the MAC address of the non-AP STA 1 and an RA field set to the MAC address of the AP STA 1. The association request frame may include complete information of non-AP STA 1, non-AP STA 2, and non-AP STA 3 to request links to be setup (one link between AP STA 1 and non-AP STA 1, one link between AP STA 2 and non-AP STA 2, and one link between AP STA 3 and non-AP STA 3) and a ML element that indicates the MLD MAC address of the non-AP MLD 1130. The association request frame may also include a recipient MAC address or a recipient ID field in the frame header of the association request frame or the frame body of the association request frame that includes a MAC address for the non-collocated AP MLD 1160, an MLD ID for the non-collocated AP MLD 1160, or a flag having a value to signal that the non-AP MLD 1130 requests association with the non-collocated AP MLD 1160.

AP STA 1, affiliated with the AP MLD 1 1120, may send an association response frame to non-AP STA 1 affiliated with the non-AP MLD 1130 with a TA field of the association response frame is set to the MAC address of the AP STA 1, an RA field of the association response frame set to the MAC address of the non-AP STA 1, and link IDs in the per-STA profile subelements of an ML element of the association response frame determined for the association of the non-AP MLD 1130 with the non-collocated AP MLD 3 1160, to indicate successful ML setup 1140. In some embodiments, where the non-AP MLD 1130 requests association with only STAs of the collocated MLD 1 1120, the link IDs may be same link IDs associated with the AP STAs 1, 2, and 3 for the links 1, 2, and 3 with the non-AP STAs 1, 2, and 3 of the non-AP MLD 1130. The association response frame may include complete information of AP STA 1, AP STA 2, and AP STA 3 and an ML element that indicates the MLD MAC addresses of the AP STAs 1, 2, and 3 of the AP MLD 1 1120 and values of the link IDs for the links 1, 2, and 3. After successful ML setup between the non-AP MLD 1130 and the AP MLD 1 1120, three links are setup (LINK 1 between AP 1 and non-AP STA 1, LINK 2 between AP 2 and non-AP STA 2, and LINK 3 between AP STA 3 and non-AP STA 3) as shown in the post association state 1110.

In some embodiments, the non-AP MLD 1130 may associate with less than all the links available from the AP MLD 1 1120 for various reasons. For instance, in some embodiments, the non-AP MLD 1130 may only be capable of establishing two of the links.

In some embodiments, the non-AP MLD 1130 may establish a link between non-AP STA 3 and AP STA 6 of the collocated AP MLD 2 1150 of the non-collocated AP MLD 3 1160 because, e.g., the AP STA 6 may have a better signal-to-noise ratio than the signal-to-noise ratio of the channel with the AP STA 3 of AP MLD 1 1120. In such circumstances, the non-AP MLD 1130 may include a per-STA profile element in the association request frame that includes a link ID associated with the AP STA 6 and a MAC address of the AP STA 6 of the AP MLD 2 1150 of the non-collocated AP MLD 3 1160. The AP STA 1 may generate the association response frame with a new link ID created for the AP STA 6 of the AP MLD 2 1150 of the non-collocated AP MLD 3 1160 and include the new link ID in the link ID field of a per-STA profile subelement of a ML element to communicate the new link ID to the non-AP MLD 1130. In such embodiments, the AP STA 1 of the collocated MLD 1 1120 may also generate a mapping table with the new link ID for the non-AP STA 3 of the non-AP MLD 1130 that is associated with the MAC address and link ID of the AP STA 6 of the AP MLD 2 1150 of the non-collocated AP MLD 1160.

During the association process, the AP MLD 1120 may establish communications protocols including identification of any parameters that differ from default parameters, preferential communications protocols, and/or negotiate communications protocols for the links.

FIG. 1C depicts an embodiment of a system 1200 including multiple MLDs to implement association logic circuitry, in accordance with one or more example embodiments. System 1200 may transmit or receive as well as generate, decode, and interpret transmissions between an AP MLD 1210 and multiple MLDs 1230, 1290, 1292, 1294, 1296, and 1298, associated with the AP MLD 1210. The AP MLD 1210 may be wired and wirelessly connected to each of the MLDs 1230, 1290, 1292, 1294, 1296, and 1298.

In some embodiments, the AP MLD 1210 may one of multiple AP MLDs affiliated with a collocated AP MLD (not shown) and MLD 1230 may include one or more computer systems similar to that of the example machines/systems of FIGS. 5, 6, 7, and 8.

Each MLD 1230, 1290, 1292, 1294, 1296, and 1298 may include association logic circuitry, such as the association logic circuitry 1250 of MLD 1230, to associate with the non-collocated AP MLD via the AP MLD 1210 to establish TxOPs on, e.g., a 6 GHz channel.

Each of the MLDs 1230, 1290, 1292, 1294, 1296, and 1298 may transmit an association request frame to the AP MLD 1210 and include in the association request frame a MAC address for the non-collocated AP MLD, an MLD ID for the non-collocated AP MLD, or a flag to signal that the association request frame, while addressed to the AP MLD 1210 in the RA, is a request addressed for the non-collocated AP MLD.

The association request frame may comprise per-STA profile subelements that identify AP STAs of the AP MLD 1210 and, in some instances, per-STA profile subelements that identify AP STAs of the other AP MLDs affiliated with the non-collocated MLD. The AP MLD 1210 may generate and transmit an association response frame responsive to each of the association request frames, indicative of success or failure to establish links with the non-collocated AP MLD. The association response frames may include link IDs created to represent links between the MLDs 1230, 1290, 1292, 1294, 1296, and 1298 and the AP MLD 1210 as well as link IDs to representative of links established between one or more AP STAs of other AP MLDs that are affiliated with the non-collocated AP MLD. The AP MLD 1210 may also create a mapping table to track the link IDs to representative of links established between one or more AP STAs of other AP MLDs that are affiliated with the non-collocated AP MLD. In some embodiments, the AP MLD 1210 may include the link IDs representative of links established between one or more AP STAs of other AP MLDs that are affiliated with the non-collocated AP MLD, in a non-collocated link ID field in per-STA profile subelements of a ML element in the association response frames transmitted to the MLDs 1230, 1290, 1292, 1294, 1296, and 1298.

The AP MLD 1210 and MLD 1230 may comprise processor(s) 1201 and memory 1231, respectively. The processor(s) 1201 may comprise any data processing device such as a microprocessor, a microcontroller, a state machine, and/or the like, and may execute instructions or code in the memory 1211. The memory 1211 may comprise a storage medium such as Dynamic Random Access Memory (DRAM), read only memory (ROM), buffers, registers, cache, flash memory, hard disk drives, solid-state drives, or the like. The memory 1211 may store the frames, frame structures, frame headers, etc., 1212 and may also comprise code to generate, scramble, encode, decode, parse, and interpret MAC frames and/or PHY frames and physical layer protocol data units (PPDUs).

The baseband processing circuitry 1218 may comprise a baseband processor and/or one or more circuits to implement an MLD station management entity (MM-SME) and a station management entity (SME) per link. The MM-SME may coordinate management of, communications between, and interactions between SMEs for the links.

In some embodiments, the SME may interact with a MAC layer management entity to perform MAC layer functionality and a PHY management entity to perform PHY functionality. In such embodiments, the baseband processing circuitry 1218 may interact with processor(s) 1201 to coordinate higher layer functionality with MAC layer and PHY functionality.

In some embodiments, the baseband processing circuitry 1218 may interact with one or more analog devices to perform PHY functionality such as scrambling, encoding, modulating, and the like. In other embodiments, the baseband processing circuitry 1218 may execute code to perform one or more of the PHY functionality such as scrambling, encoding, modulating, and the like.

The MAC layer functionality may execute MAC layer code stored in the memory 1211. In further embodiments, the MAC layer functionality may interface the processor(s) 1201.

The MAC layer functionality may communicate with the PHY via the SME to transmit a MAC frame such as a multiple-user (MU) ready to send (RTS), referred to as a MU-RTS, in a PHY frame such as an extremely high throughput (EHT) MU PPDU to the MLD 1230. The MAC layer functionality may generate frames such as management, data, and control frames.

The PHY may prepare the MAC frame for transmission by, e.g., determining a preamble to prepend to a MAC frame to create a PHY frame. The preamble may include one or more short training field (STF) values, long training field (LTF) values, and signal (SIG) field values. A wireless network interface 1222 or the baseband processing circuitry 1218 may prepare the PHY frame as a scrambled, encoded, modulated PPDU in the time domain signals for the radio 1224. Furthermore, the TSF timer 1205 may provide a timestamp value to indicate the time at which the PPDU is transmitted.

After processing the PHY frame, a radio 1225 may impress digital data onto subcarriers of RF frequencies for transmission by electromagnetic radiation via elements of an antenna array or antennas 1224 and via the network 1280 to a receiving MLD STA of a MLD such as the MLD 1230.

The wireless network I/F 1222 also comprises a receiver. The receiver receives electromagnetic energy, extracts the digital data, and the analog PHY and/or the baseband processor 1218 decodes a PHY frame and a MAC frame from a PPDU.

The MLD 1230 may receive a PPDU of the EHT MU PPDU from the AP MLD 1210 via the network 1280. The MLD 1230 may comprise processor(s) 1231 and memory 1241. The processor(s) 1231 may comprise any data processing device such as a microprocessor, a microcontroller, a state machine, and/or the like, and may execute instructions or code in the memory 1241. The memory 1241 may comprise a storage medium such as Dynamic Random Access Memory (DRAM), read only memory (ROM), buffers, registers, cache, flash memory, hard disk drives, solid-state drives, or the like. The memory 1241 may store 1242 the frames, frame structures, frame headers, etc., and may also comprise code to generate, scramble, encode, decode, parse, and interpret MAC frames and/or PHY frames (PPDUs).

The baseband processing circuitry 1248 may comprise a baseband processor and/or one or more circuits to implement a SME and the SME may interact with a MAC layer management entity to perform MAC layer functionality and a PHY management entity to perform PHY functionality. In such embodiments, the baseband processing circuitry 1248 may interact with processor(s) 1231 to coordinate higher layer functionality with MAC layer and PHY functionality.

In some embodiments, the baseband processing circuitry 1218 may interact with one or more analog devices to perform PHY functionality such as descrambling, decoding, demodulating, and the like. In other embodiments, the baseband processing circuitry 1218 may execute code to perform one or more of the PHY functionalities such as descrambling, decoding, demodulating, and the like.

The MLD 1230 may receive the PPDU of the EHT MU PPDU at the antennas 1258, which pass the signals along to the FEM 1256. The FEM 1256 may amplify and filter the signals and pass the signals to the radio 1254. The radio 1254 may filter the carrier signals from the signals and determine if the signals represent a PPDU. If so, analog circuitry of the wireless network I/F 1252 or physical layer functionality implemented in the baseband processing circuitry 1248 may demodulate, decode, descramble, etc. the PPDU. The baseband processing circuitry 1248 may identify, parse, and interpret a MAC service data unit (MSDU) from the physical layer service data unit (PSDU) of the EHT MU PPDU.

FIG. 1D is a block diagram of a radio architecture 1300 such as the wireless communications I/F 1222 and 1252 in accordance with some embodiments that may be implemented in, e.g., the AP MLD 1210 and/or the MLD 1230 of FIG. 1C. The radio architecture 1300 may include radio front-end module (FEM) circuitry 1304a-b, radio IC circuitry 1306a-b and baseband processing circuitry 1308a-b. The radio architecture 1300 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1304a-b may include a WLAN or Wi-Fi FEM circuitry 1304a and a Bluetooth (BT) FEM circuitry 1304b. The WLAN FEM circuitry 1304a may include a receive signal path comprising circuitry configured to operate on WLAN RF signals received from one or more antennas 1301, to amplify the received signals and to provide the amplified versions of the received signals to the WLAN radio IC circuitry 1306a for further processing. The BT FEM circuitry 1304b may include a receive signal path which may include circuitry configured to operate on BT RF signals received from one or more antennas 1301, to amplify the received signals and to provide the amplified versions of the received signals to the BT radio IC circuitry 1306b for further processing. FEM circuitry 1304a may also include a transmit signal path which may include circuitry configured to amplify WLAN signals provided by the radio IC circuitry 1306a for wireless transmission by one or more of the antennas 1301. In addition, FEM circuitry 1304b may also include a transmit signal path which may include circuitry configured to amplify BT signals provided by the radio IC circuitry 1306b for wireless transmission by the one or more antennas. In the embodiment of FIG. 1D, although FEM 1304a and FEM 1304b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1306a-b as shown may include WLAN radio IC circuitry 1306a and BT radio IC circuitry 1306b. The WLAN radio IC circuitry 1306a may include a receive signal path which may include circuitry to down-convert WLAN RF signals received from the FEM circuitry 1304a and provide baseband signals to WLAN baseband processing circuitry 1308a. BT radio IC circuitry 1306b may in turn include a receive signal path which may include circuitry to down-convert BT RF signals received from the FEM circuitry 1304b and provide baseband signals to BT baseband processing circuitry 1308b. WLAN radio IC circuitry 1306a may also include a transmit signal path which may include circuitry to up-convert WLAN baseband signals provided by the WLAN baseband processing circuitry 1308a and provide WLAN RF output signals to the FEM circuitry 1304a for subsequent wireless transmission by the one or more antennas 1301. BT radio IC circuitry 1306b may also include a transmit signal path which may include circuitry to up-convert BT baseband signals provided by the BT baseband processing circuitry 1308b and provide BT RF output signals to the FEM circuitry 1304b for subsequent wireless transmission by the one or more antennas 1301. In the embodiment of FIG. 1D, although radio IC circuitries 1306a and 1306b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1308a-b may include a WLAN baseband processing circuitry 1308a and a BT baseband processing circuitry 1308b. The WLAN baseband processing circuitry 1308a may include a memory, such as, for example, a set of RAM arrays in a Fast Fourier Transform or Inverse Fast Fourier Transform block (not shown) of the WLAN baseband processing circuitry 1308a. Each of the WLAN baseband circuitry 1308a and the BT baseband circuitry 1308b may further include one or more processors and control logic to process the signals received from the corresponding WLAN or BT receive signal path of the radio IC circuitry 1306a-b, and to also generate corresponding WLAN or BT baseband signals for the transmit signal path of the radio IC circuitry 1306a-b. Each of the baseband processing circuitries 1308a and 1308b may further include physical layer (PHY) and medium access control layer (MAC) circuitry, and may further interface with a device for generation and processing of the baseband signals and for controlling operations of the radio IC circuitry 1306a-b.

Referring still to FIG. 1D, according to the shown embodiment, WLAN-BT coexistence circuitry 1313 may include logic providing an interface between the WLAN baseband circuitry 1308a and the BT baseband circuitry 1308b to enable use cases requiring WLAN and BT coexistence. In addition, a switch circuitry 1303 may be provided between the WLAN FEM circuitry 1304a and the BT FEM circuitry 1304b to allow switching between the WLAN and BT radios according to application needs. In addition, although the antennas 1301 are depicted as being respectively connected to the WLAN FEM circuitry 1304a and the BT FEM circuitry 1304b, embodiments include within their scope the sharing of one or more antennas as between the WLAN and BT FEMs, or the provision of more than one antenna connected to each of FEM 1304a or 1304b.

In some embodiments, the front-end module circuitry 1304a-b, the radio IC circuitry 1306a-b, and baseband processing circuitry 1308a-b may be provided on a single radio card, such as wireless network interface card (NIC) 1302. In some other embodiments, the one or more antennas 1301, the FEM circuitry 1304a-b and the radio IC circuitry 1306a-b may be provided on a single radio card. In some other embodiments, the radio IC circuitry 1306a-b and the baseband processing circuitry 1308a-b may be provided on a single chip or integrated circuit (IC), such as IC 1312.

In some embodiments, the wireless NIC 1302 may include a WLAN radio card and may be configured for Wi-Fi communications, although the scope of the embodiments is not limited in this respect. In some of these embodiments, the radio architecture 1300 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 1300 may be part of a Wi-Fi communication station (STA) such as a wireless access point (AP), a base station or a mobile device including a Wi-Fi device. In some of these embodiments, radio architecture 1300 may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2020, IEEE 802.11ay-2021, IEE 802.11ba-2021, IEEE 802.11ax-2021, and/or IEEE 802.11be standards and/or proposed specifications for WLANs, although the scope of embodiments is not limited in this respect. The radio architecture 1300 may also be suitable to transmit and/or receive communications in accordance with other techniques and standards.

In some embodiments, the radio architecture 1300 may be configured for high-efficiency Wi-Fi (HEW) communications in accordance with the IEEE 802.11ax-2021 standard. In these embodiments, the radio architecture 1300 may be configured to communicate in accordance with an OFDMA technique, although the scope of the embodiments is not limited in this respect.

In some other embodiments, the radio architecture 1300 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1D, the BT baseband circuitry 1308b may be compliant with a Bluetooth (BT) connectivity specification such as Bluetooth 5.0, or any other iteration of the Bluetooth specification.

In some embodiments, the radio architecture 1300 may include other radio cards, such as a cellular radio card configured for cellular (e.g., 5GPP such as LTE, LTE-Advanced or 7G communications).

In some IEEE 802.11 embodiments, the radio architecture 1300 may be configured for communication over various channel bandwidths including bandwidths having center frequencies of about 2.4 GHz, 5 GHz, and 6 GHz. The various bandwidths may include bandwidths of about 20 MHz, 40 MHz, 80 MHz, 160 MHz, 240 MHz, and 320 MHz with contiguous or non-contiguous bandwidths having increments of 20 MHz, 40 MHz, 80 MHz, 160 MHz, 240 MHz, and 320 MHz. The scope of the embodiments is not limited with respect to the above center frequencies, however.

FIG. 1E illustrates FEM circuitry 1400 such as WLAN FEM circuitry 1304a shown in FIG. 1 D in accordance with some embodiments. Although the example of FIG. 1E is described in conjunction with the WLAN FEM circuitry 1304a, the example of FIG. 1E may be described in conjunction with other configurations such as the BT FEM circuitry 1304b.

In some embodiments, the FEM circuitry 1400 may include a TX/RX switch 1402 to switch between transmit mode and receive mode operation. The FEM circuitry 1400 may include a receive signal path and a transmit signal path. The receive signal path of the FEM circuitry 1400 may include a low-noise amplifier (LNA) 1406 to amplify received RF signals 1403 and provide the amplified received RF signals 1407 as an output (e.g., to the radio IC circuitry 1306a-b (FIG. 1D)). The transmit signal path of the circuitry 1304a may include a power amplifier (PA) to amplify input RF signals 1409 (e.g., provided by the radio IC circuitry 1306a-b), and one or more filters 1412, such as band-pass filters (BPFs), low-pass filters (LPFs) or other types of filters, to generate RF signals 1415 for subsequent transmission (e.g., by one or more of the antennas 1301 (FIG. 1D)) via an example duplexer 1414.

In some dual-mode embodiments for Wi-Fi communication, the FEM circuitry 1400 may be configured to operate in the 2.4 GHz frequency spectrum, the 5 GHz frequency spectrum, or the 6 GHz frequency spectrum. In these embodiments, the receive signal path of the FEM circuitry 1400 may include a receive signal path duplexer 1404 to separate the signals from each spectrum as well as provide a separate LNA 1406 for each spectrum as shown. In these embodiments, the transmit signal path of the FEM circuitry 1400 may also include a power amplifier 1410 and a filter 1412, such as a BPF, an LPF or another type of filter for each frequency spectrum and a transmit signal path duplexer 1404 to provide the signals of one of the different spectrums onto a single transmit path for subsequent transmission by the one or more of the antennas 1301 (FIG. 1D). In some embodiments, BT communications may utilize the 2.4 GHz signal paths and may utilize the same FEM circuitry 1400 as the one used for WLAN communications.

FIG. 1F illustrates radio IC circuitry 1506a in accordance with some embodiments. The radio IC circuitry 1306a is one example of circuitry that may be suitable for use as the WLAN or BT radio IC circuitry 1306a/1306b (FIG. 1D), although other circuitry configurations may also be suitable. Alternatively, the example of FIG. 1F may be described in conjunction with the example BT radio IC circuitry 1306b.

In some embodiments, the radio IC circuitry 1306a may include a receive signal path and a transmit signal path. The receive signal path of the radio IC circuitry 1306a may include at least mixer circuitry 1502, such as, for example, down-conversion mixer circuitry, amplifier circuitry 1506 and filter circuitry 1508. The transmit signal path of the radio IC circuitry 1306a may include at least filter circuitry 1512 and mixer circuitry 1514, such as, for example, upconversion mixer circuitry. Radio IC circuitry 1306a may also include synthesizer circuitry 1504 for synthesizing a frequency 1505 for use by the mixer circuitry 1502 and the mixer circuitry 1514. The mixer circuitry 1502 and/or 1514 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 1F illustrates only a simplified version of a radio IC circuitry, and may include, although not shown, embodiments where each of the depicted circuitries may include more than one component. For instance, mixer circuitry 1514 may each include one or more mixers, and filter circuitries 1508 and/or 1512 may each include one or more filters, such as one or more BPFs and/or LPFs according to application needs. For example, when mixer circuitries are of the direct-conversion type, they may each include two or more mixers.

In some embodiments, mixer circuitry 1502 may be configured to down-convert RF signals 1407 received from the FEM circuitry 1304a-b (FIG. 1D) based on the synthesized frequency 1505 provided by synthesizer circuitry 1504. The amplifier circuitry 1506 may be configured to amplify the down-converted signals and the filter circuitry 1508 may include an LPF configured to remove unwanted signals from the down-converted signals to generate output baseband signals 1507. Output baseband signals 1507 may be provided to the baseband processing circuitry 1308a-b (FIG. 1D) for further processing. In some embodiments, the output baseband signals 1507 may be zero-frequency baseband signals, although this is not a requirement. In some embodiments, mixer circuitry 1502 may comprise passive mixers, although the scope of the embodiments is not limited in this respect.

In some embodiments, the mixer circuitry 1514 may be configured to up-convert input baseband signals 1511 based on the synthesized frequency 1505 provided by the synthesizer circuitry 1504 to generate RF output signals 1409 for the FEM circuitry 1304a-b. The baseband signals 1511 may be provided by the baseband processing circuitry 1308a-b and may be filtered by filter circuitry 1512. The filter circuitry 1512 may include an LPF or a BPF, although the scope of the embodiments is not limited in this respect.

In some embodiments, the mixer circuitry 1502 and the mixer circuitry 1514 may each include two or more mixers and may be arranged for quadrature down-conversion and/or upconversion respectively with the help of synthesizer 1504. In some embodiments, the mixer circuitry 1502 and the mixer circuitry 1514 may each include two or more mixers each configured for image rejection (e.g., Hartley image rejection). In some embodiments, the mixer circuitry 1502 and the mixer circuitry 1514 may be arranged for direct down-conversion and/or direct upconversion, respectively. In some embodiments, the mixer circuitry 1502 and the mixer circuitry 1514 may be configured for super-heterodyne operation, although this is not a requirement.

Mixer circuitry 1502 may comprise, according to one embodiment: quadrature passive mixers (e.g., for the in-phase (I) and quadrature phase (Q) paths). In such an embodiment, RF input signal 1407 from FIG. 1F may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1505 of synthesizer 1504 (FIG. 1F). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1407 (FIG. 1E) may comprise a balanced signal, although the scope of the embodiments is not limited in this respect. The I and Q baseband output signals may be provided to low-noise amplifier, such as amplifier circuitry 1506 (FIG. 1F) or to filter circuitry 1508 (FIG. 1F).

In some embodiments, the output baseband signals 1507 and the input baseband signals 1511 may be analog baseband signals, although the scope of the embodiments is not limited in this respect. In some alternate embodiments, the output baseband signals 1507 and the input baseband signals 1511 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1504 may be a fractional-N synthesizer or a fractional N/N+1 synthesizer, although the scope of the embodiments is not limited in this respect as other types of frequency synthesizers may be suitable. For example, synthesizer circuitry 1504 may be a delta-sigma synthesizer, a frequency multiplier, or a synthesizer comprising a phase-locked loop with a frequency divider. According to some embodiments, the synthesizer circuitry 1504 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1504 may be provided by a voltage-controlled oscillator (VCO), although that is not a requirement. A divider control input may further be provided by either of the baseband processing circuitry 1308a-b (FIG. 1D) depending on the desired output frequency 1505. In some embodiments, a divider control input (e.g., N) may be determined from a look-up table (e.g., within a Wi-Fi card) based on a channel number and a channel center frequency as determined or indicated by the example application processor 1310. The application processor 1310 may include, or otherwise be connected to, one of the example secure signal converter 101 or the example received signal converter 103 (e.g., depending on which device the example radio architecture is implemented in).

In some embodiments, synthesizer circuitry 1504 may be configured to generate a carrier frequency as the output frequency 1505, while in other embodiments, the output frequency 1505 may be a fraction of the carrier frequency (e.g., one-half the carrier frequency, one-third the carrier frequency). In some embodiments, the output frequency 1505 may be a LO frequency (fLO).

FIG. 1G illustrates a functional block diagram of baseband processing circuitry 1308a in accordance with some embodiments. The baseband processing circuitry 1308a is one example of circuitry that may be suitable for use as the baseband processing circuitry 1308a (FIG. 1D), although other circuitry configurations may also be suitable. Alternatively, the example of FIG. 1F may be used to implement the example BT baseband processing circuitry 1308b of FIG. 1D.

The baseband processing circuitry 1308a may include a receive baseband processor (RX BBP) 1602 for processing receive baseband signals 1509 provided by the radio IC circuitry 1306a-b (FIG. 1D) and a transmit baseband processor (TX BBP) 1604 for generating transmit baseband signals 1511 for the radio IC circuitry 1306a-b. The baseband processing circuitry 1308a may also include control logic 1606 for coordinating the operations of the baseband processing circuitry 1308a.

In some embodiments (e.g., when analog baseband signals are exchanged between the baseband processing circuitry 1308a-b and the radio IC circuitry 1306a-b), the baseband processing circuitry 1308a may include ADC 1610 to convert analog baseband signals 1609 received from the radio IC circuitry 1306a-b to digital baseband signals for processing by the RX BBP 1602. In these embodiments, the baseband processing circuitry 1308a may also include DAC 1612 to convert digital baseband signals from the TX BBP 1604 to analog baseband signals 1611.

In some embodiments that communicate OFDM signals or OFDMA signals, such as through baseband processor 1308a, the transmit baseband processor 1604 may be configured to generate OFDM or OFDMA signals as appropriate for transmission by performing an inverse fast Fourier transform (IFFT). The receive baseband processor 1602 may be configured to process received OFDM signals or OFDMA signals by performing an FFT. In some embodiments, the receive baseband processor 1602 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1D, in some embodiments, the antennas 1301 (FIG. 1D) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1301 may each include a set of phased-array antennas, although embodiments are not so limited.

Although the radio architecture 1300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 6^{th} generation mobile networks, 3GPP, long term evolution (LTE), LTE advanced, enhanced data rates for GSM Evolution (EDGE), or the like. Other embodiments may be used in various other devices, systems, and/or networks.

FIGS. 2A-2C illustrate embodiments of channels and subchannels (or resource units) that can facilitate multiple transmissions simultaneously such as a EHT PPDU. FIG. 2A illustrates an embodiment of transmissions 2010 between four stations and an AP on four different subchannels (or resource units) of a channel via OFDMA. Grouping subcarriers into groups of resource units is referred to as subchannelization. Subchannelization defines subchannels that can be allocated to stations depending on their channel conditions and service requirements. An OFDMA system may also allocate different transmit powers to different subchannels.

In the present embodiment, the OFDMA STA1, OFDMA STA2, OFDMA STA3, and OFDMA STA4 may represent transmissions on a four different subchannels of the channel. For instance, transmissions 2010 may represent an 80 MHz channel with four 20 MHz bandwidth PPDUs using frequency division multiple access (FDMA). Such embodiments may include, e.g., 1 PPDU per 20 MHz bandwidth, 2 PPDU in a 40 MHz bandwidth, and 4 PPDUs in an 80 MHz bandwidth. As a comparison, FIG. 2B illustrates an embodiment of an orthogonal frequency division multiplexing (OFDM) transmission 2015 for the same channel as FIG. 2A. The OFDM transmission 2015 may use the entire channel bandwidth.

FIG. 2C illustrates an embodiment of a 20 Megahertz (MHz) bandwidth 2020 on a channel that illustrates different resource unit (RU) configurations 2022, 2024, 2026, and 2028. In OFDMA, for instance, an OFDM symbol is constructed of subcarriers, the number of which is a function of the physical layer protocol data unit (PPDU) (also referred to as the PHY frame) bandwidth. There are several subcarrier types: 1) Data subcarriers which are used for data transmission; 2) Pilot subcarriers which are utilized for phase information and parameter tracking; and 3) unused subcarriers which are not used for data/pilot transmission. The unused subcarriers are the direct current (DC) subcarrier, the Guard band subcarriers at the band edges, and the Null subcarriers.

The RU configuration 2022 illustrates an embodiment of nine RUs that each include 26 tones (or subcarriers) for data transmission including the two sets of 13 tones on either side of the DC. The RU configuration 2024 illustrates the same bandwidth divided into 5 RUs including four RUs with 52 tones and one RU with 26 tones about the DC for data transmission. The RU configuration 2026 illustrates the same bandwidth divided into 3 RUs including two RUs with 106 tones and one RU with 26 tones about the DC for data transmission. And the RU configuration 2028 illustrates the same bandwidth divided into 2 RUs including two RUs with 242 tones about the DC for data transmission. Embodiments may be capable of additional or alternative bandwidths such as such as 40 MHz, 80 MHz, 160 MHz, 240 MHz, and 320 MHz.

Many embodiments support RUs of 26-tone RU, 52-tone RU, 106-tone RU, 242-tone RU, 484-tone RU, 996-tone RU, 2×996-tone RU, and 4×996-tone RU. In some embodiments, RUs that are the same size or larger than 242-tone RUs are defined as large size RUs and RUs that are smaller than 242-tones RUs are defined as small size RUs. In some embodiments, small size RUs can only be combined with small size RUs to form small size MRUs. In some embodiments, large size RUs can only be combined with large size RUs to form large size MRUs.

FIG. 2D illustrates an embodiment of a HE MU PPDU 2100 in the form of an 802.11, orthogonal frequency division multiple access (OFDMA) packet on a 20 MHz channel of, e.g., a 2.4 GHz link, a 5 GHz link, a 6 GHz link, or any other frequency. In some embodiments, the baseband processing circuitry, such as the baseband processing circuitry 1218 in FIG. 1C, may transmit a HE MU PPDU 2100 transmission on the 6 GHz carrier frequency, optionally with beamforming. In some embodiments, the HE MU PPDU 2100 may comprise a MAC association request or response frame, an MAC reassociation request or response frame, a MAC authentication frame, and/or the like.

The HE MU PPDU 2100 may comprise a legacy preamble 2110 to notify other devices in the vicinity of the source STA, such as an AP STA, that the 20 MHz channel is in use for a duration included in the legacy preamble 2110. The legacy preamble 2110 may comprise one or more short training fields (L-STFs), one or more long training fields (L-LTFs), and one or more signal fields (L-SIG and RL-SIG).

The HE MU PPDU 2100 may also comprise a HE preamble 2120 to identify a subsequent 6 GHz carrier link transmission as well as the STAs that are the targets of the transmission. Similarly, the HE preamble 2120 may comprise one or more short training fields (HE-STFs), one or more long training fields (HE-LTFs), and one or more signal fields (HE-SIG).

After the HE preamble 2120, the HE MU PPDU 2100 may comprise a data portion 2140 that includes a single user (SU) or multiple user (MU) packet. FIG. 2D illustrates the MU packet with four designated RUs. Note that the number and size of the RUs may vary between packets based on the number of target STAs and the types of payloads in the data portions 2140.

FIG. 2E depicts another embodiment of the MAC Management frame in the HE MU PPDU 2200. In some embodiments, the HE MU PPDU 2200 may be a frame format used for a DL transmission to one or more STAs. In the HE MU PPDU 2200, the MAC management frame may comprise two legacy (L) short training fields (STFs) with an 8 microseconds duration each, a legacy (L) signal (SIG) field with a four microsecond duration, a repeated, legacy signal field (RL-SIG) with a 4 microsecond duration, and a U-SIG with 2 symbols having a 4 microsecond duration each. The HE MU PPDU 2200 format may also comprise a HE signal field (HE-SIG) with 2 symbols at 4 microseconds each, an HE STF, a number of HE-LTFs, a data field, and a packet extension (PE) field. In some embodiments, the data field may comprise may be a MAC management frame.

As illustrated in FIG. 2F, the data field of the HE MU PPDU 2200 may comprise a MAC management frame 2210 such as a MAC association request or response frame, an MAC reassociation request or response frame, a MAC authentication frame, and/or the like. The data field may comprise an MPDU (PSDU) such as a MAC association request frame comprising a recipient MAC address or recipient ID field in the MAC header (frame header) to identify a non-collocated AP MLD as a recipient of the MAC association request frame. The MAC association response frame and MAC authentication frame may not include the recipient MAC address or recipient ID field in the MAC header.

The MAC association request frame may include a 2 octet frame control field, a 2 octet duration field, a 6 octet address 1 field, a 6 octet address 2 field, a 6 octet address 3 field, a 2 octet sequence control field, a 0 or 4 octet high-throughput (HT) control field, and the recipient MAC address or recipient ID field in the MAC header. MAC association request frame may also include a variable length frame body field, and a 4 octet frame check sequence field comprising a value, such as a 32-bit cyclic redundancy code (CRC), to check the validity of and/or correct preceding frame.

The Duration field may be the time, in microseconds, required to transmit the pending management frame, plus, in some embodiments, one acknowledgement (ack) frame and one or more short interframe spaces (SIFSs). If the calculated duration includes a fractional microsecond, that value may be rounded up to the next higher integer.

The address 1 field of the MAC association request frame may comprise the address of the intended receiver such as an AP STA of an AP MLD of a non-collocated AP MLD. The address 2 field may be the address the transmitter such as a non-AP MLD that transmitted the MAC association request frame. The address 3 field may be the basic service set identifier (BSSID) of the AP MLD of the non-collocated AP MLD.

The HT control field may be present in management frames as determined by the +HTC subfield of the frame control field.

The recipient MAC address or recipient ID field may include a MAC address associated with the non-collocated AP MLD, a MLD ID, or a flag such as one or more bits to identify the non-collocated AP MLD as a recipient of the MAC association request frame.

The frame body may include one or more fields and/or elements such as the fields and/or elements depicted in FIGS. 2G-2M. The frame check sequence (FCS) field may include a sequence of bits such as a 32-bit cyclic redundancy check (CRC).

FIG. 2G depicts an embodiment of a frame body 2232 of an association request frame or reassociation request frame such as the management frame 2210 shown in FIG. 2F. The frame body 2232 format may include one or more other fields and/or elements along with a ML element, an extremely high throughput (EHT) capabilities element, and a TID-to-link mapping element. The ML element may comprise fields as shown in the ML element 2238 depicted in FIG. 2J.

The EHT capabilities element may comprise a number of fields that are used to advertise the EHT capabilities of an EHT STA. The EHT capabilities element may comprise an element ID field, a length field, an element ID Extension field, an EHT MAC capabilities information field, an EHT PHY capabilities information field, a Supported EHT-MCS And NSS Set field, and an EHT PPE Thresholds field.

The TID-to-link mapping field may comprise one or two TID-To-Link Mapping elements if a non-AP STA affiliated with a non-AP MLD initiates both an association with an AP MLD and a TID-to-link mapping negotiation.

FIG. 2H depicts an embodiment of a frame body 2234 of an association response frame or reassociation response frame such as the management frame 2210 shown in FIG. 2F. The frame body 2234 format may include one or more other fields and/or elements along with a target wake time (TWT) element, a ML element, an extremely high throughput (EHT) capabilities element, an EHT operation element, and a TID-to-link mapping element. The TWT element may comprise a target wake time field that contains a positive integer corresponding to a TSF time at which the STA requests to wake, or 0 when the TWT setup command subfield contains the value corresponding to the command “Request TWT”. When a TWT responding STA with Grouping Support equal to 0 transmits a TWT element to the TWT requesting STA, the TWT element contains a value in the target wake time field corresponding to a TSF time at which the TWT responding STA requests the TWT requesting STA to wake and it does not contain the TWT group assignment field.

The ML element may comprise fields as shown in the ML element 2238 depicted in FIG. 2J. The EHT capabilities element may comprise a number of fields that are used to advertise the EHT capabilities of an EHT STA. The EHT capabilities element may comprise an Element ID field, a Length field, an Element ID Extension field, an EHT MAC Capabilities Information field, an EHT PHY Capabilities Information field, a Supported EHT-MCS And NSS Set field, and an EHT PPE thresholds field.

The EHT operation element may comprise an EHT operation parameters field, a disabled subchannel bitmap field, an EHT default PE duration field, a group addressed buffered unit (BU) indication limit field, a group address BU indication exponent field, and a reserved field. The EHT operation information present subfield is set to 1 if the EHT operation information field is present and set to 0 otherwise.

The TID-to-link mapping field may comprise one or two TID-To-Link Mapping elements if a non-AP STA affiliated with a non-AP MLD initiates both an association with an AP MLD and a TID-to-link mapping negotiation.

FIG. 2I depicts an embodiment of a frame body 2236 of an authentication frame such as the management frame 2210 shown in FIG. F. The frame body 2236 format may include one or more other fields and/or elements along with a ML element and a vendor specific element. The ML element may comprise fields as shown in the ML element 2238 depicted in FIG. 2J.

FIG. 2J depicts an embodiment of a multi-link (ML) element 2238 of an association frame, a reassociation frame, and an authentication frame such as the management frame 2210 shown in FIG. 2F. The ML element 2238 format may include an element ID field, a length field, an element ID extension field, a ML control field, a common info field, and a link info field. Depending on the variant (indicated by the Type subfield) of this element, particular field(s) or subfield(s) within a field can be absent. The Element ID, Length, and Element ID Extension fields may identify the format of the element, the length of the element and identify element extensions.

The ML control field may identify the type of or variant of the ML element and may comprise a presence bitmap. The presence bitmap subfield is used to indicate the presence of various subfields in the common info field and has different format for different variants of the ML element.

The common info field carries information that is common to all the links except for link ID Info subfield and BSS parameters change count subfield that are for the link on which the ML element is sent. The common info field is depicted in FIG. 2K.

The link info field carries information specific to the links and is optionally present. When the link info field is present, it contains one or more subelements such as the per-STA profile subelement.

FIG. 2K depicts an embodiment of a common info field 2240 of an association frame a reassociation frame, and an authentication frame such as the management frame 2210 shown in FIG. 2F. The common info field carries information that is common to all the links except for Link ID Info subfield and BSS parameters change count subfield that are for the link on which the ML element is sent. The common info field 2240 may include a common info length field, an MLD MAC address field, a link ID info field, a BSS parameters change count field, a medium synchronization delay information field, an enhanced ML (EML) capabilities field, an MLD capabilities and operations field, and an AP MLD ID field.

The common info length subfield indicates the number of octets in the Common Info field, including one octet for the Common Info Length subfield. The MLD MAC Address subfield specifies the MAC Address of the MLD with which the STA transmitting the basic ML element is affiliated.

In some embodiments, the link ID info subfield of the common info field is included in the association request frame transmitted by the non-AP MLD to the collocated AP MLD of the non-collocated to add a new recipient MAC address or recipient ID field in the link ID info subfield. The new recipient MAC address or recipient ID field may include the MAC address of the non-collocated AP MLD or a MLD ID for the non-collocated AP MLD to address the association request frame to the non-collocated AP MLD affiliated with the AP MLD that receives the association request frame. In some embodiment, the link ID field is also included in the link ID info field and may include the value of the link ID of an AP STA of the collocated AP MLD that receives the association request frame. In other embodiments, the link ID field is not present in the link ID info subfield.

In other embodiments, the recipient MAC address or recipient ID field may be included in the frame header (or MAC header) of the association request frame. In such embodiments, the link ID info field of the may not be present in the common info field if the basic ML element is sent by a non-AP STA.

In some embodiments, the recipient MAC address or recipient ID field may comprise a value of a flag such as one or more bits to identify the intended recipient of the association request frame as the collocated AP MLD that receives the association request frame or to identify the intended recipient of the association request frame as the non-collocated AP MLD affiliated with the collocated AP MLD that receives the association request frame via a RA.

The BSS parameters change count subfield in the common info field carries an unsigned integer, initialized to 0. The value carried in the subfield is incremented by 1 when a critical update and occurs to the operational parameters for the AP that is affiliated with an AP MLD which is described in the basic ML element.

In some embodiments, the link ID Info subfield and the BSS parameters change count subfield are present in the common info field of the basic ML element, when the element is carried in a management frame transmitted by an AP, except for the authentication frame. In some embodiments, the medium synchronization delay information subfield in the common info subfield is not present if the basic ML element is sent by a non-AP STA. When the basic ML element is included in a frame sent by an AP, the condition for the presence of the medium synchronization delay information subfield in the common info field is defined by a medium access recovery procedure.

The EML capabilities subfield contains a number of subfields that are used to advertise the capabilities for enhanced ML single radio (EMLSR) operation and enhanced ML multi-radio (EMLMR) operation. The MLD capabilities and operations subfield may be present in the common info field of the basic ML element carried in a beacon, probe response, (re)association request, and (re)association response frames.

The AP MLD ID subfield indicates the identifier of the AP MLD whose MLD information is carried in the basic ML element. In some embodiments, the AP MLD ID subfield is not present in the basic ML element included in a frame sent by a non-AP STA affiliated with a non-AP MLD. In some embodiments, the AP MLD ID subfield is not present in the basic ML element when the element is carried in a beacon, (re)association response, authentication, or probe response frame that is not a ML probe response.

FIG. 2L depicts an embodiment of a link ID info subfield 2242 of a common info field 2240 shown in FIG. 2K of an association request frame, a reassociation request frame, and an authentication frame such as the management frame 2210 shown in FIG. 2F. In some embodiments, the link ID info subfield of the common info field is included in the association request frame transmitted by the non-AP MLD to the collocated AP MLD of the non-collocated to add a new recipient MAC address or recipient ID field in the link info ID subfield. In other embodiments, the link ID info subfield comprise the new recipient MAC address or recipient ID field to address the association request frame to the non-collocated AP MLD rather than to the AP MLD (affiliated with the non-collocated AP MLD) at which the association request frame is received in accordance with address 1 in the frame header of the association request frame. In other embodiment, the new recipient MAC address or recipient ID field resides in the frame header as a field in the frame header or a subfield of a frame control field in the frame header.

The new recipient MAC address or recipient ID field may include a MAC address, MLD ID, or a flag indicative of the non-collocated AP MLD affiliated with the collocated AP MLD that is identified as a recipient of the association request frame.

FIG. 2M depicts an embodiment of a link info subfield 2244 of a ML element 2238 shown in FIG. 2J of an association request frame, association response frame, a reassociation request frame, reassociation response frame, and an authentication frame such as the management frame 2210 shown in FIG. F. The link info field may comprise one or more subelements. In the present embodiment, the link info field comprises a frame format for a per-STA profile subelement appended with other subelements such as other per-STA profile subelements. The per-STA profile subelement may comprise a subelement ID that may carry a value of zero to indicate the subelement is a per-STA subelement. The length field may comprise a value indicative of the length of the subelement including the STA control field, the variable length STA info field and the variable length STA profile field. The STA control field may comprise a complete profile field to include the complete profile of a STA associated with the per-STA profile subelement, a STA MAC address present field, other fields, and a reserved field. The STA MAC address present field may indicate whether or not a STA MAC address field is included in the STA info field. The STA info field may comprise one or more fields including a STA MAC address field and the STA MAC address field may comprise a MAC address for the STA that is described in the per-STA profile subelement.

In some embodiments, the link info subfield 2244 of the ML element is included in the association request frame or reassociation request frame transmitted by a non-AP MLD to a collocated AP-MLD affiliated with a non-collocated AP MLD. In many embodiments, the link info field may comprise a per-STA profile subelement for each non-AP STA that the non-AP MLD is requesting to link to an AP STA (except, the non-AP STA included in the ML element) with the association request frame or reassociation request frame. If the non-AP MLD is requesting to setup links with a non-collocated AP MLD, the association request frame or reassociation request frame may include a per-STA profile subelement for each link to identify the AP STA of the non-collocated AP MLD with which to setup a link. For example, if the non-collocated AP MLD is affiliated with a first AP MLD and a second AP MLD, the non-AP MLD may transmit an association request frame to the first AP MLD of the non-collocated AP MLD. The association request frame may include three requested links for non-AP STA 1, non-AP STA 2, and non-AP STA 3. In some embodiments, the link info field 2244 may include five per-STA subelements. Two of the per-STA subelements may include the complete profiles, link IDs, and STA MAC addresses to describe non-AP STA 2 and non-AP STA 3. The other three per-STA subelements may include at least the link IDs and STA MAC addresses for three AP STAs of the non-collocated AP MLD such as one or more AP STAs of the first AP MLD and/or one or more AP STAs of the second AP MLD. In some embodiments, the other three per-STA subelements for the AP STAs may also include the complete profiles for the AP STAs at least to the extent that the non-AP MLD obtained through a discovery protocol. For example, the other three per-STA subelements may include the link ID and MAC address for two AP STAs of the first AP MLD and one AP STA of the second AP MLD.

In some embodiments, if the non-AP MLD requests the setup of links with two of the AP STAs of the first AP MLD (the AP MLD that received the association request frame), the link info field may include three per-STA profile subelements. Two of the per-STA subelements may include the complete profiles, link IDs, and MAC addresses of the three non-AP STAs and one of the per-STA profile subelements may comprise the complete profile, link ID, and MAC address of the AP STA of the second AP MLD. In other words, the non-AP MLD may only include a per-STA profile for the AP STA that is not collocated with the first AP MLD that received the association request frame.

In some embodiments, if the non-AP MLD requests the setup of links with three of the AP STAs of the first AP MLD (the AP MLD that received the association request frame), the link info field may include two per-STA profile subelements. The two per-STA subelements may include the complete profiles, link IDs, and MAC addresses of the two non-AP STAs (in addition to the information for the third non-AP STA in the ML element). The association logic circuitry of the first AP MLD may determine that the lack of additional per-STA subelements for AP STAs indicates the intention to link to the AP STAs collocated with the first AP MLD.

In some embodiments, the link info subfield 2244 of the ML element is included in the association response frame or reassociation response frame transmitted by the collocated AP-MLD in response to an association request frame received from a non-AP MLD to associate with the collocated AP MLD or with a non-collocated AP MLD affiliated with the collocated AP MLD that is the recipient of the association request frame as identified in the RA in the frame header.

In some embodiments, for the association response frame or the reassociation response frame, the STA control field may include a new non-collocated link ID field to include a value for a new link ID generated for a link between a non-AP STA and an AP STA of another collocated AP MLD that is affiliated with a non-collocated AP MLD. For instance, a first AP MLD may receive an association request frame from the non-AP MLD that requests setup of a link between a non-AP STA of the non-AP MLD and an AP STA of a second AP MLD where the first AP MLD and the second AP MLD are affiliated with the non-collocated AP MLD. The first AP MLD may generate the new link ID for the link and include the value of the new link ID in the non-collocated link ID field.

In other embodiments, rather than or in addition to inclusion of the new link ID in the non-collocated link ID field, the first AP MLD may create a mapping table entry for a mapping table such as the mapping table 2246 shown in FIG. 2N.

FIG. 2N depicts an embodiment of a mapping table 2246 maintained by association logic circuitry of a first AP MLD in response to generation of a new link ID that identifies a link between a non-AP STA and an AP STA of a second AP MLD, where the first AP MLD and the second AP MLD are affiliated with a non-collocated AP MLD. For instance, the first AP MLD may generate the new link ID in response to receipt of an association request frame received from the non-AP MLD that identifies the non-collocated AP MLD as the recipient of the association request frame and identifies a request for a link setup between the non-AP STA and an AP STA of the second AP MLD.

An entry of the mapping table 2246 may include two fields, a collocated AP MLD field and a non-collocated AP MLD field. The collocated AP MLD field may include a link ID field and an AP MLD MAC address or MLD ID field. The link ID field may include the value of link ID for the link between the non-AP STA and the AP STA of the second AP MLD. The AP MLD MAC address or MLD ID field may comprise a value for the MAC address or MLD ID of the second AP MLD.

In the same entry of the mapping table 2246, the non-collocated AP MLD field may comprise a link ID field to associate the content of the link ID field of the non-collocated AP MLD field with the content of the collocated AP MLD field. The link ID field of the non-collocated AP MLD field may comprise a value of the new link ID created by the first AP MLD to represent the link between the non-AP STA and the AP STA of the second AP MLD. In some embodiments, the non-collocated AP MLD field may comprise other fields such as a MAC address or MLD ID that may include a value for, e.g., a MAC address or MLD ID for the second AP MLD.

FIGS. 2O-P illustrates an example of a PPDU 2260 with a MAC management frame that may be transmitted by an MLD STA to an AP MLD. In FIG. 2O, the PPDU 2260 format may be used for a transmission of an association frame, a reassociation frame, or an authentication frame.

The PPDU 2260 format may comprise an OFDM PHY preamble, an OFDM PHY header, a PSDU, tail bits, and pad bits. The PHY header may contain the following fields: length, rate, a reserved bit, an even parity bit, and the service field. in terms of modulation, the length, rate, reserved bit, and parity bit (with 6 zero tail bits appended) may constitute a separate single OFDM symbol, denoted signal, which is transmitted with the combination of BPSK modulation and a coding rate of R=1/2.

The PSDU (with 6 zero tail bits and pad bits appended), denoted as data, may be transmitted at the data rate described in the rate field and may constitute multiple OFDM symbols. The tail bits in the signal symbol may enable decoding of the rate and length fields immediately after reception of the tail bits. The rate and length fields may be required for decoding the data field of the PPDU.

In FIG. 2P, the data field of the PPDU may comprise an MPDU such as a MAC management frame 2270. The MAC management frame 2270 may include a 2 octet frame control field, a 2 octet duration field, a 6 octet RA field, and a 4 octet frame check sequence field comprising a value, such as a 32-bit CRC, to check the validity of and/or correct preceding frame.

In several embodiments, the value of the addr1 field of the MAC management frame is set to the address of the recipient of the MAC management frame 2270.

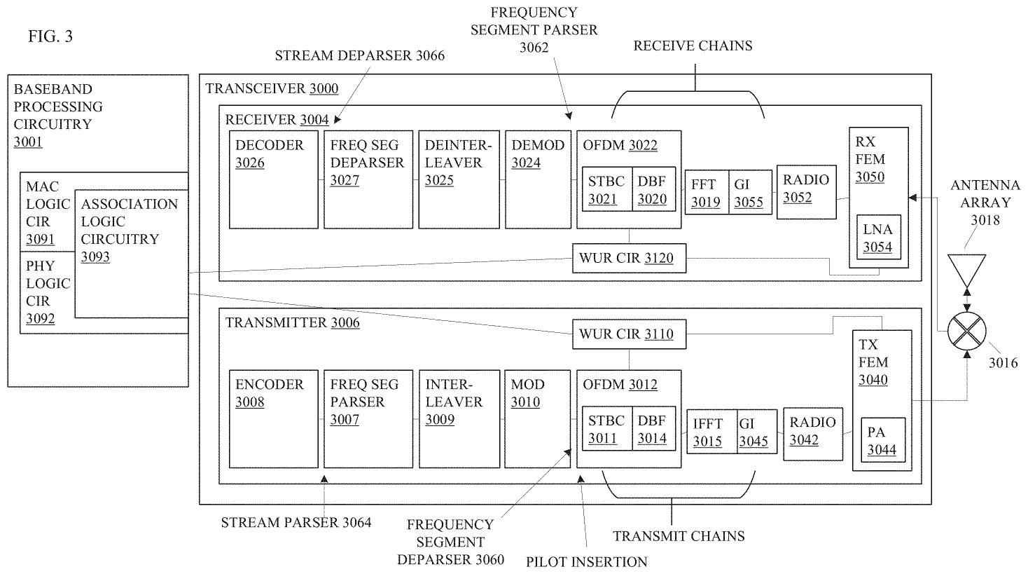

FIG. 3 depicts an embodiment of an apparatus to generate, transmit, receive, and interpret or decode PHY frames and MAC frames. The apparatus comprises a transceiver 3000 coupled with baseband processing circuitry 3001. The baseband processing circuitry 3001 may comprise a MAC logic circuitry 3091 and PHY logic circuitry 3092. In other embodiments, the baseband processing circuitry 3001 may be included on the transceiver 3000.

The MAC logic circuitry 3091 and PHY logic circuitry 3092 may comprise code executing on processing circuitry of a baseband processing circuitry 3001; circuitry to implement operations of functionality of the MAC or PHY; or a combination of both. In the present embodiment, the MAC logic circuitry 3091 and PHY logic circuitry 3092 may comprise association logic circuitry 3093 to implement a non-collocated AP MLD affiliated with two or more collocated AP MLDs. For example, the association logic circuitry of an AP MLD and a non-AP MLD may implement authentication and association including link setup for channels such as a 2.4 GHz channel, a 5 GHz channel, or a 6 GHz channel between a non-AP MLD and one or more collocated AP MLDs associated with the non-collocated AP MLD via one of the collocated AP MLDs.

The MAC logic circuitry 3091 may determine a frame such as a MAC management frame and the PHY logic circuitry 3092 may determine the physical layer protocol data unit (PPDU) by prepending the frame, also called a MAC protocol data unit (MPDU), with a physical layer (PHY) preamble for transmission of the MAC management frame via the antenna array 3018. The PHY logic circuitry 3092 may cause transmission of the MAC management frame in the PPDU.

The transceiver 3000 comprises a receiver 3004 and a transmitter 3006. Embodiments have many different combinations of modules to process data because the configurations are deployment specific. FIG. 3 illustrates some of the modules that are common to many embodiments. In some embodiments, one or more of the modules may be implemented in circuitry separate from the baseband processing circuitry 3001. In some embodiments, the baseband processing circuitry 3001 may execute code in processing circuitry of the baseband processing circuitry 3001 to implement one or more of the modules.

In the present embodiment, the transceiver 3000 also includes WUR circuitry 3110 and 3120. The WUR circuitry 3110 may comprise circuitry to use portions of the transmitter 3006 (a transmitter of the wireless communications I/F such as wireless communications I/Fs 1216 and 1246 of FIG. 1C) to generate a WUR packet. For instance, the WUR circuitry 3110 may generate, e.g., an OOK signal with OFDM symbols to generate a WUR packet for transmission via the antenna array 3018. In other embodiments, the WUR may comprise an independent circuitry that does not use portions of the transmitter 3006.

Note that a MLD such as the AP MLD 1210 in FIG. 1C may comprise multiple transmitters to facilitate concurrent transmissions on multiple contiguous and/or non-contiguous carrier frequencies.

The transmitter 3006 may comprise one or more of or all the modules including an encoder 3008, a stream deparser 3066, a frequency segment parser 3007, an interleaver 3009, a modulator 3010, a frequency segment deparser 3060, an OFDM 3012, an Inverse Fast Fourier Transform (IFFT) module 3015, a GI module 3045, and a transmitter front end 3040. The encoder 3008 of transmitter 3006 receives and encodes a data stream destined for transmission from the MAC logic circuitry 3091 with, e.g., a binary convolutional coding (BCC), a low-density parity check coding (LDPC), and/or the like. After coding, scrambling, puncturing and post-FEC (forward error correction) padding, a stream parser 3064 may optionally divide the data bit streams at the output of the FEC encoder into groups of bits. The frequency segment parser 3007 may receive data stream from encoder 3008 or streams from the stream parser 3064 and optionally parse each data stream into two or more frequency segments to build a contiguous or non-contiguous bandwidth based upon smaller bandwidth frequency segments. The interleaver 3009 may interleave rows and columns of bits to prevent long sequences of adjacent noisy bits from entering a BCC decoder of a receiver.

The modulator 3010 may receive the data stream from interleaver 3009 and may impress the received data blocks onto a sinusoid of a selected frequency for each stream via, e.g., mapping the data blocks into a corresponding set of discrete amplitudes of the sinusoid, or a set of discrete phases of the sinusoid, or a set of discrete frequency shifts relative to the frequency of the sinusoid. In some embodiments, the output of modulator 3010 may optionally be fed into the frequency segment deparser 3060 to combine frequency segments in a single, contiguous frequency bandwidth of, e.g., 320 MHz. Other embodiments may continue to process the frequency segments as separate data streams for, e.g., a non-contiguous 160+160 MHz bandwidth transmission.

After the modulator 3010, the data stream(s) are fed to an OFDM 3012. The OFDM 3012 may comprise a space-time block coding (STBC) module 3011, and a digital beamforming (DBF) module 3014. The STBC module 3011 may receive constellation points from the modulator 3010 corresponding to one or more spatial streams and may spread the spatial streams to a greater number of space-time streams. Further embodiments may omit the STBC.

The OFDM 3012 impresses or maps the modulated data formed as OFDM symbols onto a plurality of orthogonal subcarriers, so the OFDM symbols are encoded with the subcarriers or tones. The OFDM symbols may be fed to the DBF module 3014. Generally, digital beam forming uses digital signal processing algorithms that operate on the signals received by, and transmitted from, an array of antenna elements. Transmit beamforming processes the channel state to compute a steering matrix that is applied to the transmitted signal to optimize reception at one or more receivers. This is achieved by combining elements in a phased antenna array in such a way that signals at particular angles experience constructive interference while others experience destructive interference.

The IFFT module 3015 may perform an inverse discrete Fourier transform (IDFT) on the OFDM symbols to map on the subcarriers. The guard interval (GI) module 3045 may insert guard intervals by prepending to the symbol a circular extension of itself. The GI module 3045 may also comprise windowing to optionally smooth the edges of each symbol to increase spectral decay.

The output of the GI module 3045 may enter the radio 3042 to convert the time domain signals into radio signals by combining the time domain signals with subcarrier frequencies to output into the transmitter front end module (TX FEM) 3040. The transmitter front end 3040 may comprise a with a power amplifier (PA) 3044 to amplify the signal and prepare the signal for transmission via the antenna array 3018. In many embodiments, entrance into a spatial reuse mode by a communications device such as a station or AP may reduce the amplification by the PA 3044 to reduce channel interference caused by transmissions.

The transceiver 3000 may also comprise duplexers 3016 connected to antenna array 3018. The antenna array 3018 radiates the information bearing signals into a time-varying, spatial distribution of electromagnetic energy that can be received by an antenna of a receiver. In several embodiments, the receiver 3004 and the transmitter 3006 may each comprise its own antenna(s) or antenna array(s).

The transceiver 3000 may comprise a receiver 3004 for receiving, demodulating, and decoding information bearing communication signals. The receiver 3004 may comprise a receiver front-end module (RX FEM) 3050 to detect the signal, detect the start of the packet, remove the carrier frequency, and amplify the subcarriers via a low noise amplifier (LNA) 3054 to output to the radio 3052. The radio 3052 may convert the radio signals into time domain signals to output to the GI module 3055 by removing the subcarrier frequencies from each tone of the radio signals.

The receiver 3004 may comprise a GI module 3055 and a fast Fourier transform (FFT) module 3019. The GI module 3055 may remove the guard intervals and the windowing and the FFT module 3019 may transform the communication signals from the time domain to the frequency domain.

The receiver 3004 may also comprise an OFDM 3022, a frequency segment parser 3062, a demodulator 3024, a deinterleaver 3025, a frequency segment deparser 3027, a stream deparser 3066, and a decoder 3026. An equalizer may output the weighted data signals for the OFDM packet to the OFDM 3022. The OFDM 3022 extracts signal information as OFDM symbols from the plurality of subcarriers onto which information-bearing communication signals are modulated.

The OFDM 3022 may comprise a DBF module 3020, and an STBC module 3021. The received signals are fed from the equalizer to the DBF module 3020. The DBF module 3020 may comprise algorithms to process the received signals as a directional transmission directed toward to the receiver 3004. And the STBC module 3021 may transform the data streams from the space-time streams to spatial streams.

The output of the STBC module 3021 may enter a frequency segment parser 3062 if the communication signal is received as a single, contiguous bandwidth signal to parse the signal into, e.g., two or more frequency segments for demodulation and deinterleaving.

The demodulator 3024 demodulates the spatial streams. Demodulation is the process of extracting data from the spatial streams to produce demodulated spatial streams. The deinterleaver 3025 may deinterleave the sequence of bits of information. The frequency segment deparser 3027 may optionally deparse frequency segments as received if received as separate frequency segment signals or may deparse the frequency segments determined by the optional frequency segment parser 3062. The decoder 3026 decodes the data from the demodulator 3024 and transmits the decoded information, the MPDU, to the MAC logic circuitry 3091.

The MAC logic circuitry 3091 may parse the MPDU based upon a format defined in the communications device for a frame to determine the particular type of frame by determining the type value and the subtype value. The MAC logic circuitry 3091 may then interpret the remainder of MPDU.

While the description of FIG. 3 focuses primarily on a single spatial stream system for simplicity, many embodiments are capable of multiple spatial stream transmissions and use parallel data processing paths for multiple spatial streams from the PHY logic circuitry 3092 through to transmission. Further embodiments may include the use of multiple encoders to afford implementation flexibility.

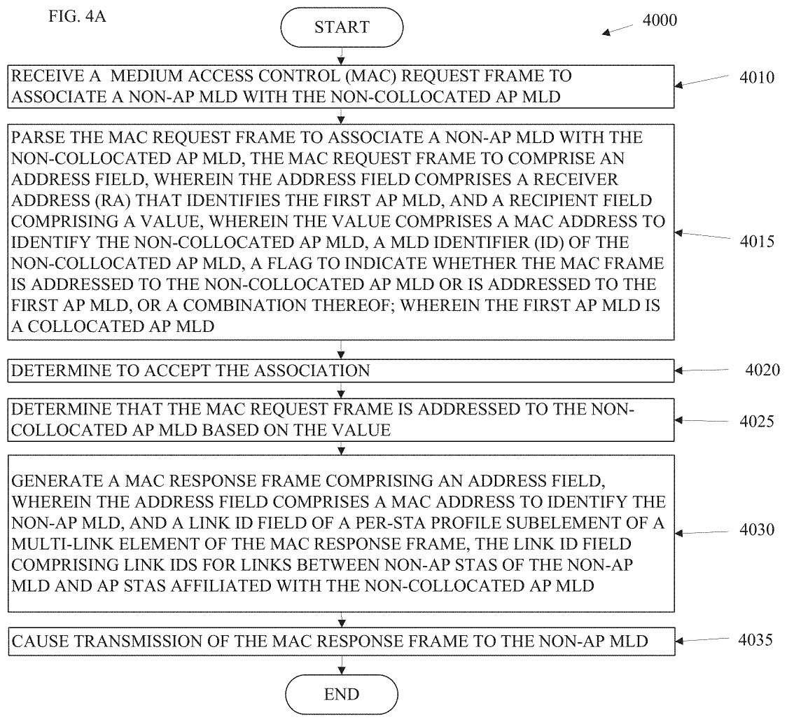

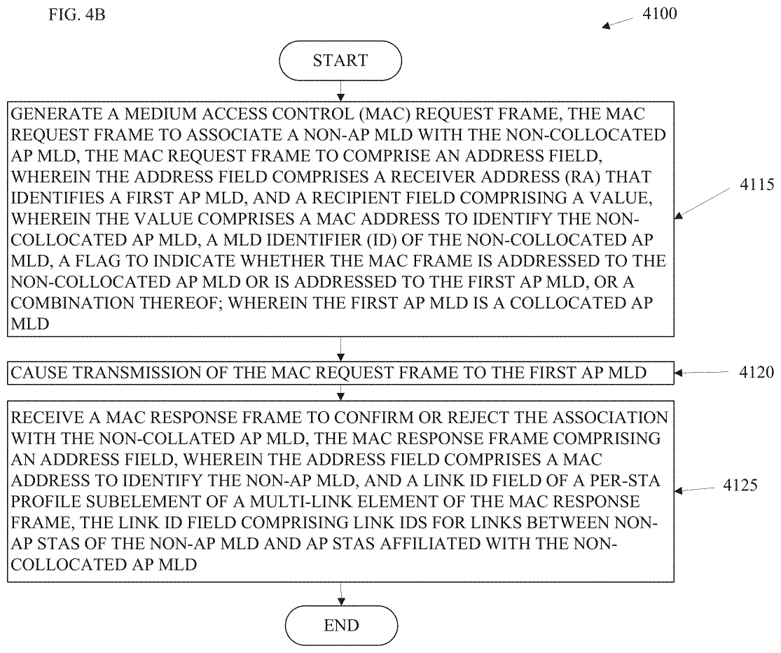

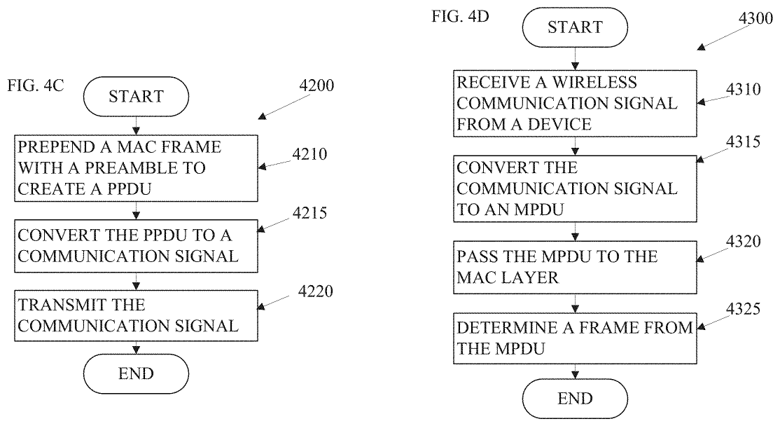

FIG. 4A depicts an embodiment of a flowchart of a process 4000 to implement association logic circuitry such as the association logic circuitry discussed in FIGS. 1-3. At element 4010, association logic circuitry of a first AP MLD (e.g., the association logic circuitry 1220 of the AP MLD 1210) may receive a medium access control (MAC) request frame to associate a non-AP MLD (e.g., the association logic circuitry 1250 of the AP MLD 1230) with the non-collocated AP MLD. The MAC request frame may, for example, comprise an association request frame, a reassociation request frame, or an authentication frame.

The association logic circuitry of the first AP MLD may parse the MAC request frame to associate a non-AP MLD with the non-collocated AP MLD (element 4015). The MAC request frame may comprise an address field, wherein the address field comprises a receiver address (RA) that identifies the first AP MLD. The MAC request frame may also comprise a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof. Furthermore, the first AP MLD may be a collocated AP MLD affiliated with the non-collocated AP MLD. In many embodiments, a second AP MLD may also be a collocated AP MLD affiliated with the non-collocated AP MLD.

In some embodiments, parsing the MAC request frame may parse the MAC request frame to determine a value of an address field, wherein the address field comprises a receiver address (RA) that identifies the first AP MLD. Upon receipt of at least a portion of the MAC request frame, the PHY may decode the receiver address to determine if the frame is addressed to the first AP MLD. If the MAC request frame is not addressed to the first AP MLD, the first AP MLD may ignore the remainder of the frame as being addressed to another STA. When the receiver address is addressed to the first AP MLD, the first AP MLD may continue to receive, decode, and interpret the remainder of the MAC request frame including a value of the recipient field for the non-collocated AP MLD.

The recipient field may comprise a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof. If the value identifies the first AP MLD, the first AP MLD may process the MAC request frame to setup links with the first AP MLD. If the value identifies the non-collocated AP MLD, the MAC request frame is addressed to the non-collocated AP MLD affiliated with the first AP MLD and the association logic circuitry of the first AP MLD may process the per-STA profile subelements of the link info field of the ML element in the frame body of the MAC request frame to determine the AP STAs for which the MAC request frame is requesting links.

The per-STA profile subelements may identify one or more AP STAs of the first AP MLD, one or more AP STAs of one or more other AP MLDs affiliated with the non-collocated AP MLD, or a combination thereof. For instance, the MAC request frame may identify one or more AP STAs of the first AP MLD and, in response, the association logic circuitry may determine whether the non-AP STAs can operate on links with the AP STAs of the first AP MLD. In other embodiments, the MAC request frame may identify one or more AP STAs of a second AP MLD affiliated with the non-collocated AP MLD and the first AP MLD may determine whether one or more non-AP STAs can operate on links with the AP STAs of the second AP MLD.

If the non-AP STAs of the non-AP MLD can operate on the links with the identified AP STAs based on comparison of the complete profiles of the non-AP STAs against the complete profiles of the AP STAs identified in the MAC request frame, the first AP MLD may determine to accept the association identified by the MAC request frame (element 4020).

After accepting the association, the first AP MLD may generate a MAC response frame to indicate a successful association (element 4030). The MAC response frame may comprise an address field, wherein the address field comprises a MAC address to identify the non-AP MLD, and a link ID field of a per-STA profile subelement of a ML element of the MAC response frame. The link ID field of the per-STA profile subelement of the ML element of the MAC response frame may comprise link IDs for links between non-AP STAs of the non-AP MLD and AP STAs affiliated with the non-collocated AP MLD.

After generating the MAC response frame, the association logic circuitry of the first AP MLD may cause transmission of the MAC response frame to the non-AP MLD (element 4035 via a PHY and an antenna of the first AP MLD.

In some embodiments, parsing the MAC request frame may parse the frame header to determine the value for the non-collocated AP MLD ID, the value of the flag, or a combination thereof. In other embodiments, parsing the MAC request frame may parse a ML element in a frame body of the MAC request frame to determine the value for the non-collocated AP MLD ID, the value of the flag, or a combination thereof.

In some embodiments, the MAC address of the non-collocated AP MLD is different from a MAC address of the first AP MLD and/or the value for an MLD ID to identify the non-collocated AP MLD is different from a value of an MLD ID for the first AP MLD.

In some embodiments, the logic circuitry of the first AP MLD may use, for authentication, the same security keys for different groups of collocated AP STAs of a non-collocated AP MLD, wherein the different groups of collocated AP STAs are non-collocated. For instance, the second AP MLD may use the same security keys as the first AP MLD to authenticate the non-AP MLD for establishing a link between a non-AP STA of the non-AP MLD and an AP STA of the second AP MLD. For instance, during or after the establishment of a link between the non-AP STA and an AP STA of the second AP MLD, the first AP MLD may share the establishment of the link with the second AP MLD via communication between the first AP MLD and the second AP MLD of the non-collocated AP MLD.

In other embodiments, the logic circuitry of the first AP MLD may use, for authentication, different security keys for different groups of collocated AP STAs of a non-collocated AP MLD, wherein the different groups of collocated AP STAs are non-collocated. In such embodiments, for example, the second AP MLD may use different security keys than the first AP MLD to authenticate the non-AP MLD. In such embodiments, the first AP MLD may obtain the different security keys from the second AP MLD and may provide the different security keys to the non-AP MLD in the MAC response frame or in another frame. In other embodiments, the second AP MLD may communicate the different keys directly with the non-AP MLD.

FIG. 4B depicts another embodiment of a flowchart of a process 4100 to implement association logic circuitry. At element 4110, association logic circuitry of a non-AP MLD (e.g., the association logic circuitry 1220 of the AP MLD 1210 or the association logic circuitry 1250 of MLD STA 1230 shown FIG. 1C) may generate a medium access control (MAC) request frame to associate the non-AP MLD with a non-collocated AP MLD via a first AP MLD. The MAC request frame to comprise an address field comprising a receiver address (RA) that identifies a first AP MLD as the recipient of the MAC request frame. The MAC request frame may also comprise a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof. Furthermore, the first AP MLD may be a collocated AP MLD affiliated with the non-collocated AP MLD and a second AP MLD may also be affiliated with the non-collocated AP MLD.

The association logic circuitry of the non-AP MLD may also generate a per-STA profile subelement included in a frame body of the MAC request frame that identifies links for non-AP STAs of the non-AP MLD. The links may include one or more links to connect the non-AP STAs with AP STAs of the first AP MLD, one or more links to connect the non-AP STAs with AP STAs of the second AP MLD, one or more links to connect the non-AP STAs of other AP MLDs affiliated with the non-collocated AP MLD, or a combination thereof.

After generating the MAC request frame, the non-AP STA may transmit the MAC request frame to the first AP MLD (element 4120) via a PHY and an antenna of the non-AP MLD.

Thereafter, the non-AP MLD may receive a MAC response frame (element 4125) from the first AP MLD to indicate whether the link setup was successful. The association logic circuitry may decode and parse the MAC response frame via PHY logic circuitry and MAC logic circuitry of the non-AP MLD. The MAC response frame may comprise an address field, wherein the address field comprises a MAC address to identify the non-AP MLD. The MAC response frame may also comprise a link ID field of per-STA profile subelements of a ML element of the MAC response frame. The link ID field of the per-STA profile subelements may comprise link IDs for links between non-AP STAs of the non-AP MLD and AP STAs affiliated with the non-collocated AP MLD.

In some embodiments, the MAC response frame comprises a new link ID in a non-collocation link ID field of a STA control field of a link info field of the ML element of the MAC response frame. In some embodiments, the value to identify the non-collocated AP MLD is different from a MAC address of the first AP MLD or the value of an MLD ID for the first AP MLD.

If the link setup was not successful, the non-AP MLD may transmit another MAC request frame to attempt to establish the links. If the MAC response frame indicates that the association was successful, the links are set up and the non-AP MLD may store link information from the MAC response frame in memory.

In some embodiments, the association logic circuitry may determine, for generation of the MAC request frame, the value of the flag, wherein the value of the flag comprises one or more bits, the value to indicate whether the MAC frame is addressed to the non-collocated AP MLD or addressed to the first AP MLD, wherein the first AP MLD is a collocated AP MLD. In some embodiments, the association logic circuitry may determine, for generation of a frame header of the MAC request frame, the value for the non-collocated AP MLD ID, the value of the flag, or a combination thereof. In some embodiments, the association logic circuitry may determine, for generation of a ML element in the frame body of the MAC request frame, the value for the non-collocated AP MLD ID, the value of the flag, or a combination thereof.

FIGS. 4C-D depict embodiments of flowcharts 4200 and 4300 to transmit, receive, and interpret communications with a frame. Referring to FIG. 4C, the flowchart 4200 may begin with receiving an MU frame from the wireless communications I/F 1216 of the AP MLD 1210 by the wireless communications I/Fs (such as wireless communications I/F 1246 of the MLD 1230, MLD 1290, MLD 1292, and MLD 1296 as shown in FIG. 1C. The MAC logic circuitry, such as the MAC logic circuitry 3091 in FIG. 1C, of each MLD of MLD 1230, MLD 1290, MLD 1292, and MLD 1296 may operate in conjunction with association logic circuitry 3093 to generate a management frame to transmit to the AP MLD 1210 as an association request frame and may pass the frame as an MAC protocol data unit (MPDU) to a PHY logic circuitry such as the PHY logic circuitry 3092 in FIG. 1C as a PSDU to include in a PHY frame. The PHY logic circuitry may also encode and transform the PSDU into OFDM symbols for transmission to the AP MLD 1210. The PHY logic circuitry may generate a preamble to prepend the PHY service data unit (PSDU) (the MPDU) to form a PHY protocol data unit (PPDU) for transmission (element 4210).

A physical layer device such as the transmitter 3006 in FIG. 3 or the wireless network interfaces 1222 and 1252 in FIG. 1A may convert the PPDU to a communication signal via a radio (element 4215). The transmitter may then transmit the communication signal via the antenna coupled with the radio (element 4220).

Referring to FIG. 4D, the flowchart 4300 begins with a receiver of a device such as the receiver 3004 in FIG. 3 receiving a communication signal via one or more antenna(s) such as an antenna element of antenna array 3018 (element 4310). The receiver may convert the communication signal into an MPDU in accordance with the process described in the preamble (element 4315). More specifically, the received signal is fed from the one or more antennas to a DBF such as the DBF 220. The DBF transforms the antenna signals into information signals. The output of the DBF is fed to OFDM such as the OFDM 3022 in FIG. 3. The OFDM extracts signal information from the plurality of subcarriers onto which information-bearing signals are modulated. Then, the demodulator such as the demodulator 3024 demodulates the signal information via, e.g., BPSK, 16-QAM (quadrature amplitude modulation), 64-QAM, 256-QAM, 1024-QAM, or 4096-QAM with a forward error correction (FEC) coding rate (1/2, 2/3, 3/4, or 5/6). And the decoder such as the decoder 3026 decodes the signal information from the demodulator via, e.g., BCC or LDPC, to extract the MPDU and pass or communicate the MPDU to MAC layer logic circuitry such as MAC logic circuitry 3091 (element 4320).

When received at the MAC layer circuitry, the MPDU may be a MAC Service Data Unit (MSDU). The MAC logic circuitry in conjunction with association logic circuitry may determine frame field values from the MSDU (MPDU from PHY) (element 4325) such as the management frame fields in the management frame shown in FIGS. 2F-2I. For instance, the MAC logic circuitry may determine frame field values such as the type and subtype field values to determine that the MAC frame is the management frame and, more specifically, an association request frame.

FIG. 5 shows a functional diagram of an exemplary communication station 500, in accordance with one or more example embodiments of the present disclosure. In one embodiment, FIG. 5 illustrates a functional block diagram of a communication station that may be suitable for use as an AP MLD 1005 (FIG. 1A) or a user device 1028 (FIG. 1A) in accordance with some embodiments. The communication station 500 may also be suitable for use as other user device(s) 1020 such as the user devices 1024 and/or 1026. The user devices 1024 and/or 1026 may include, e.g., a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 500 may include communications circuitry 502 and a transceiver 510 for transmitting and receiving signals to and from other communication stations using one or more antennas 501. The communications circuitry 502 may include circuitry that can operate the physical layer (PHY) communications and/or medium access control (MAC) communications for controlling access to the wireless medium, and/or any other communications layers for transmitting and receiving signals. The communication station 500 may also include processing circuitry 506 and memory 508 arranged to perform the operations described herein. In some embodiments, the communications circuitry 502 and the processing circuitry 506 may be configured to perform operations detailed in the above figures, diagrams, and flows.

In accordance with some embodiments, the communications circuitry 502 may be arranged to contend for a wireless medium and configure frames or packets for communicating over the wireless medium. The communications circuitry 502 may be arranged to transmit and receive signals. The communications circuitry 502 may also include circuitry for modulation/demodulation, upconversion/downconversion, filtering, amplification, etc. In some embodiments, the processing circuitry 506 of the communication station 500 may include one or more processors. In other embodiments, two or more antennas 501 may be coupled to the communications circuitry 502 arranged for sending and receiving signals. The memory 508 may store information for configuring the processing circuitry 506 to perform operations for configuring and transmitting message frames and performing the various operations described herein. The memory 508 may include any type of memory, including non-transitory memory, for storing information in a form readable by a machine (e.g., a computer). For example, the memory 508 may include a computer-readable storage device, read-only memory (ROM), random-access memory (RAM), magnetic disk storage media, optical storage media, flash-memory devices and other storage devices and media.

In some embodiments, the communication station 500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 500 may include one or more antennas 501. The antennas 501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 500 may include one or more of a keyboard, a display, a non-volatile memory port, multiple antennas, a graphics processor, an application processor, speakers, and other mobile device elements. The display may be an LCD screen including a touch screen.

Although the communication station 500 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 500 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 500 may include one or more processors and may be configured with instructions stored on a computer-readable storage device.

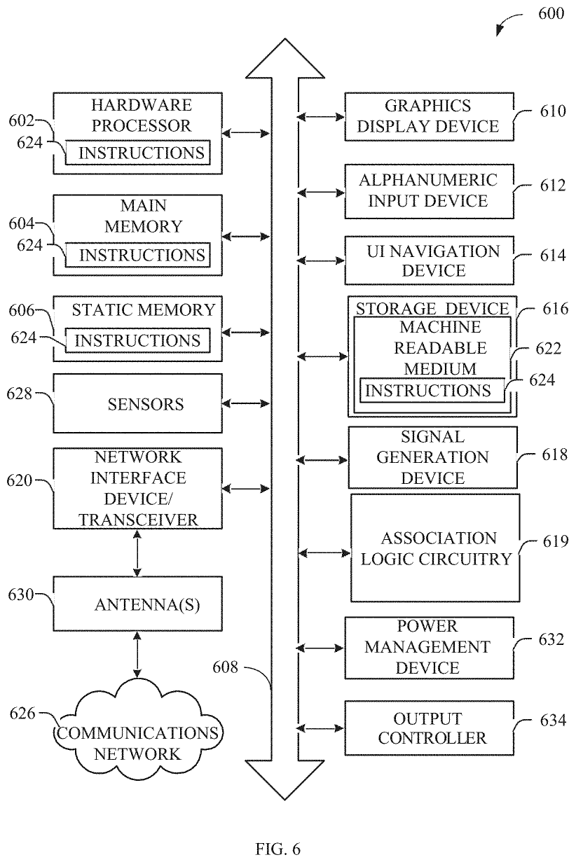

FIG. 6 illustrates a block diagram of an example of a machine 600 or system upon which any one or more of the techniques (e.g., methodologies) discussed herein may be performed. For instance, the machine may comprise an AP MLD such as the AP MLD 1005 and/or one of the user devices 1020 shown in FIG. 1A. In other embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a non-AP MLD or an AP MLD in network environments. The machine 600 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as link management. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via one or more interlinks (e.g., buses or high-speed interconnects) 608. Note that the single set of interlinks 608 may be representative of the physical interlinks in some embodiments but is not representative of the physical interlinks 608 in other embodiments. For example, the main memory 604 may couple directly with the hardware processor 602 via high-speed interconnects or a main memory bus. The high-speed interconnects typically connect two devices, and the bus is generally designed to interconnect two or more devices and include an arbitration scheme to provide fair access to the bus by the two or more devices.

The machine 600 may further include a power management device 632, a graphics display device 610, an alphanumeric input device 612 (e.g., a keyboard), and a user interface (UI) navigation device 614 (e.g., a mouse). In an example, the graphics display device 610, alphanumeric input device 612, and UI navigation device 614 may be a touch screen display. The machine 600 may additionally include a storage device (i.e., drive unit) 616, a signal generation device 618 (e.g., a speaker), an association logic circuitry 619, a network interface device/transceiver 620 coupled to antenna(s) 630, and one or more sensors 628, such as a global positioning system (GPS) sensor, a compass, an accelerometer, or other sensor. The machine 600 may include an output controller 634, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor such as the baseband processing circuitry 1218 and/or 1248 shown in FIG. 1C. The baseband processor may be configured to generate corresponding baseband signals. The baseband processor may further include physical layer (PHY) and medium access control layer (MAC) circuitry and may further interface with the hardware processor 602 for generation and processing of the baseband signals and for controlling operations of the main memory 604, the storage device 616, and/or the association logic circuitry 619. The baseband processor may be provided on a single radio card, a single chip, or an integrated circuit (IC).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within the static memory 606, or within the hardware processor 602 during execution thereof by the machine 600. In an example, one or any combination of the hardware processor 602, the main memory 604, the static memory 606, or the storage device 616 may constitute machine-readable media.

The association logic circuitry 619 may carry out or perform any of the operations and processes in relation to association with an AP MLD such as a collocated AP MLD and a non-collocated AP MLD via a MAC frame such as a MAC request frame, a MAC response frame. and/or an authentication frame transmitted in a, e.g., 2.4 GHz, 5 GHz, or 6 GHz channel or the like (e.g., flowchart 4000 shown in FIG. 4A and flowchart 4100 shown in FIG. 4B) described and shown herein. It is understood that the above are only a subset of what the association logic circuitry 619 may be configured to perform and that other functions included throughout this disclosure may also be performed by the association logic circuitry 619.

While the machine-readable medium 622 is illustrated as a single medium, the term “machine-readable medium” may include a single medium or multiple media (e.g., a centralized or distributed database, and/or associated caches and servers) configured to store the one or more instructions 624.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 600 and that cause the machine 600 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device/transceiver 620 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 620 may include one or more physical jacks (e.g., Ethernet, coaxial, or phone jacks) or one or more antennas to connect to the communications network 626. In an example, the network interface device/transceiver 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 600 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

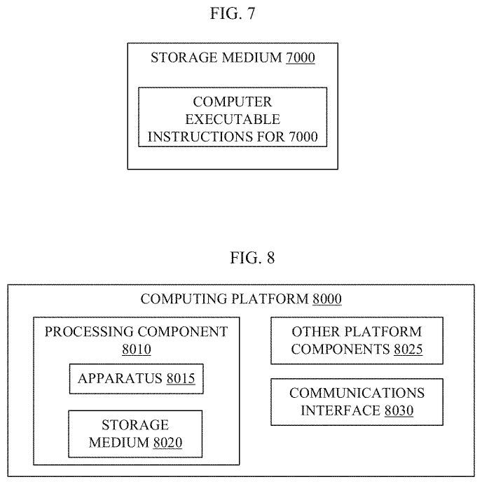

FIG. 7 illustrates an example of a storage medium 7000 to store association logic such as logic to implement the association logic circuitry 619 shown in FIG. 6 and/or the other logic discussed herein to associate a non-AP MLD with a non-collocated AP MLD. Storage medium 7000 may comprise an article of manufacture. In some examples, storage medium 7000 may include any non-transitory computer readable medium or machine-readable medium, such as an optical, magnetic or semiconductor storage. Storage medium 7000 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

FIG. 8 illustrates an example computing platform 8000 such as the MLD STAs 1210, 1230, 1290, 1292, 1294, 1296, and 1298 in FIG. 1C. In some examples, as shown in FIG. 8, computing platform 8000 may include a processing component 8010, other platform components or a communications interface 8030 such as the wireless network interfaces 1222 and 1252 shown in FIG. 1C. According to some examples, computing platform 8000 may be a computing device such as a server in a system such as a data center or server farm that supports a manager or controller for managing configurable computing resources as mentioned above. In some embodiments, the computing platform may comprise a mobile device such as a smart phone, a tablet, a notebook, a laptop, a headset, a power amplifier, a television, a speaker, a video/audio streaming device, a stereo, and/or the like.

According to some examples, processing component 8010 may execute processing operations or logic for apparatus 8015 described herein. Processing component 8010 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits (ICs), application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 8020, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. While discussions herein describe elements of embodiments as software elements and/or hardware elements, decisions to implement an embodiment using hardware elements and/or software elements may vary in accordance with any number of design considerations or factors, such as desired computational rate, power levels, heat tolerances, processing cycle budget, input data rates, output data rates, memory resources, data bus speeds and other design or performance constraints.

In some examples, other platform components 8025 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., universal serial bus (USB) memory), solid state drives (SSD) and any other type of storage media suitable for storing information.

In some examples, communications interface 8030 may include logic and/or features to support a communication interface. For these examples, communications interface 8030 may include one or more communication interfaces that operate according to various communication protocols or standards to communicate over direct or network communication links. Direct communications may occur via use of communication protocols or standards described in one or more industry standards (including progenies and variants) such as those associated with the Peripheral Component Interconnect (PCI) Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 8000 may be part of a computing device that may be, for example, a server, a server array or server farm, a web server, a network server, an Internet server, a workstation, a mini-computer, a main frame computer, a supercomputer, a network appliance, a web appliance, a distributed computing system, multiprocessor systems, processor-based systems, or combination thereof. Accordingly, various embodiments of the computing platform 8000 may include or exclude functions and/or specific configurations of the computing platform 8000 described herein.

The components and features of computing platform 8000 may comprise any combination of discrete circuitry, ASICs, logic gates and/or single chip architectures. Further, the features of computing platform 8000 may comprise microcontrollers, programmable logic arrays and/or microprocessors or any combination of the foregoing where suitably appropriate. Note that hardware, firmware and/or software elements may be collectively or individually referred to herein as “logic”.

One or more aspects of at least one example may comprise representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that make the logic or processor.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

Advantages of Some Embodiments

Several embodiments have one or more potentially advantages effects. For instance, association logic circuitry, advantageously may generate a MAC (re)association request frame or an authentication frame to associate the MAC (re)association request frame or an authentication frame with the non-collocated AP MLD. Association logic circuitry may advantageously parse a MAC (re)association request frame or an authentication frame to associate the MAC (re)association request frame or an authentication frame with the non-collocated AP MLD. Association logic circuitry may, advantageously, determine that the MAC (re)association request frame or an authentication frame is addressed to the non-collocated AP MLD based on the value in a new recipient field. Association logic circuitry may, advantageously, determine that the MAC (re)association request frame or an authentication frame is addressed to the non-collocated AP MLD based on the value in a new recipient field comprising a flag, a MAC address, and/or a MLD ID. Association logic circuitry may, advantageously generate a new link ID for a link associated with a non-collocated AP MLD. Association logic circuitry may advantageously generate a mapping table entry to store the new link ID and to associate the new link ID with a link ID and MAC address of an AP MLD affiliated with the collocated AP MLD. Association logic circuitry may advantageously generate an association response frame with the new link ID to associate a new link ID with a collocated AP MLD link ID and a collocated AP MLD MAC address or MAC ID. Association logic circuitry may advantageously describe links with one or more AP STAs of one or more AP MLDs affiliated with a collocated AP MLD in per-STA profile subelements of a ML element of an association request frame or reassociation request frame.

### EXAMPLES OF FURTHER EMBODIMENTS

The following examples pertain to further embodiments. Specifics in the examples may be used anywhere in one or more embodiments.

Example 1 is an apparatus comprising: a memory; and logic circuitry of a first access point (AP) multilink device (MLD) affiliated with a non-collocated AP MLD coupled with the memory to: parse a medium access control (MAC) request frame to associate a non-AP MLD with the non-collocated AP MLD, the MAC request frame to comprise an address field, wherein the address field comprises a receiver address (RA) that identifies the first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof, wherein the first AP MLD is a collocated AP MLD; and determine that the MAC request frame is addressed to the non-collocated AP MLD based on the value. In Example 2, the apparatus of Example 1, the logic circuitry comprising further to determine to accept the association after a determination that non-AP stations (STAs) of the non-AP MLD can operate on links with the AP STAs identified by the MAC request frame based on complete profiles of the non-AP STAs of the non-AP MLD in a multi-link element of the MAC request frame. In Example 3, the apparatus of Example 1, the logic circuitry to further: generate a MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD; and cause transmission of the MAC response frame to the non-AP MLD. In Example 4, the apparatus of Example 3, the logic circuitry to generate a new link ID for a link set up between a non-AP STA of the non-AP MLD and an AP STA of a second AP MLD affiliated with the non-collocated AP MLD. In Example 5, the apparatus of Example 4, the logic circuitry to generate a mapping table entry for the new link ID, wherein the mapping table entry comprises a collocated AP MLD field and a non-collocated AP MLD field, the collocated AP MLD field comprising an identifier for the second AP MLD and a second link ID; the non-collocated AP MLD field comprising the new link ID. In Example 6, the apparatus of Example 4, the logic circuitry to include the new link ID in a non-collocation link ID field of a STA control field of a link info field of the multi-link element of the MAC response frame. In Example 7, the apparatus of Example 1, the logic circuitry comprising baseband processing circuitry and further comprising a radio coupled with the baseband processing circuitry, and one or more antennas coupled with the radio to receive the MAC request frame. In Example 8, the apparatus of Example 1, wherein the MAC request frame comprises an association request frame, a reassociation request frame, or an authentication frame. In Example 9, the apparatus of Example 1, wherein the value to identify the non-collocated AP MLD is different from a MAC address of the first AP MLD or the value of an MLD ID for the first AP MLD. In Example 10, the apparatus of Example 1, the logic circuitry to use, for authentication, the same security keys for different groups of collocated AP STAs of a non-collocated AP MLD, wherein the different groups of collocated AP STAs are non-collocated. In Example 11, the apparatus of Example 1, the logic circuitry to use, for authentication, different security keys for different groups of collocated AP STAs of a non-collocated AP MLD, wherein the different groups of collocated AP STAs are non-collocated. In Example 12, the apparatus of Example 1, the logic circuitry to parse the MAC request frame to determine the value of the flag, wherein the value of the flag comprises one or more bits, the value to indicate whether the MAC frame is addressed to the non-collocated AP MLD or addressed to the first AP MLD, wherein the first AP MLD is a collocated AP MLD. In Example 13 is a non-transitory computer-readable medium, comprising instructions, which when executed by a processor, cause the processor to perform operations to: parse a medium access control (MAC) request frame to associate a non-AP MLD with the non-collocated AP MLD, the MAC request frame to comprise an address field, wherein the address field comprises a receiver address (RA) that identifies the first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof, wherein the first AP MLD is a collocated AP MLD; and determine that the MAC request frame is addressed to the non-collocated AP MLD based on the value. In Example 14, the non-transitory computer-readable medium of Example 13, the logic circuitry comprising further to determine to accept the association after a determination that non-AP stations (STAs) of the non-AP MLD can operate on links with the AP STAs identified by the MAC request frame based on complete profiles of the non-AP STAs of the non-AP MLD in a multi-link element of the MAC request frame. In Example 15, the non-transitory computer-readable medium of Example 13, the operations to further: generate a MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD; and cause transmission of the MAC response frame to the non-AP MLD. In Example 16, the non-transitory computer-readable medium of Example 15, the logic circuitry to generate a new link ID for a link set up between a non-AP STA of the non-AP MLD and an AP STA of a second AP MLD affiliated with the non-collocated AP MLD. In Example 17, the non-transitory computer-readable medium of Example 16, the logic circuitry to generate a mapping table entry for the new link ID, wherein the mapping table entry comprises a collocated AP MLD field and a non-collocated AP MLD field, the collocated AP MLD field comprising an identifier for the second AP MLD and a second link ID; the non-collocated AP MLD field comprising the new link ID. In Example 18, the non-transitory computer-readable medium of Example 16, the logic circuitry to include the new link ID in a non-collocation link ID field of a STA control field of a link info field of the multi-link element of the MAC response frame. In Example 19, the non-transitory computer-readable medium of Example 13, wherein the MAC request frame comprises an association request frame, a reassociation request frame, or an authentication frame. In Example 20, the non-transitory computer-readable medium of Example 13, wherein the value to identify the non-collocated AP MLD is different from a MAC address of the first AP MLD or the value of an MLD ID for the first AP MLD. In Example 21, the non-transitory computer-readable medium of Example 13, the logic circuitry to use, for authentication, the same security keys for different groups of collocated AP STAs of a non-collocated AP MLD, wherein the different groups of collocated AP STAs are non-collocated. In Example 22, the non-transitory computer-readable medium of Example 13, the logic circuitry to use, for authentication, different security keys for different groups of collocated AP STAs of a non-collocated AP MLD, wherein the different groups of collocated AP STAs are non-collocated. In Example 23, the non-transitory computer-readable medium of Example 13, the logic circuitry to parse the MAC request frame to determine the value of the flag, wherein the value of the flag comprises one or more bits, the value to indicate whether the MAC frame is addressed to the non-collocated AP MLD or addressed to the first AP MLD, wherein the first AP MLD is a collocated AP MLD.

Example 24 is a method comprising: parsing, by a first access point (AP) multilink device (MLD) affiliated with a non-collocated AP MLD, a medium access control (MAC) request frame to associate a non-AP MLD with the non-collocated AP MLD, the MAC request frame to comprise an address field, wherein the address field comprises a receiver address (RA) that identifies the first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof, wherein the first AP MLD is a collocated AP MLD; and determining that the MAC request frame is addressed to the non-collocated AP MLD based on the value. In Example 25, the method of Example 24, further comprising determining to accept the association after a determination that non-AP stations (STAs) of the non-AP MLD can operate on links with the AP STAs identified by the MAC request frame based on complete profiles of the non-AP STAs of the non-AP MLD in a multi-link element of the MAC request frame. In Example 26, the method of Example 24, further comprising: generating a MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD; and causing transmission of the MAC response frame to the non-AP MLD. In Example 27, the method of Example 26, further comprising generating a new link ID for a link set up between a non-AP STA of the non-AP MLD and an AP STA of a second AP MLD affiliated with the non-collocated AP MLD. In Example 28, the method of Example 27, further comprising generating a mapping table entry for the new link ID, wherein the mapping table entry comprises a collocated AP MLD field and a non-collocated AP MLD field, the collocated AP MLD field comprising an identifier for the second AP MLD and a second link ID; the non-collocated AP MLD field comprising the new link ID. In Example 29, the method of Example 27, further comprising including the new link ID in a non-collocation link ID field of a STA control field of a link info field of the multi-link element of the MAC response frame. In Example 30, the method of Example 24, wherein the MAC request frame comprises an association request frame, a reassociation request frame, or an authentication frame. In Example 31, the method of Example 24, wherein the value to identify the non-collocated AP MLD is different from a MAC address of the first AP MLD or the value of an MLD ID for the first AP MLD. In Example 32, the method of Example 24, further comprising using, for authentication, the same security keys for different groups of collocated AP STAs of a non-collocated AP MLD, wherein the different groups of collocated AP STAs are non-collocated. In Example 33, the method of Example 24, further comprising using, for authentication, different security keys for different groups of collocated AP STAs of a non-collocated AP MLD, wherein the different groups of collocated AP STAs are non-collocated. In Example 34, the method of Example 24, wherein parsing comprises parsing the MAC request frame to determine the value of the flag, wherein the value of the flag comprises one or more bits, the value to indicate whether the MAC frame is addressed to the non-collocated AP MLD or addressed to the first AP MLD, wherein the first AP MLD is a collocated AP MLD.

Example 35 is an apparatus comprising: a means for parsing, by a first access point (AP) multilink device (MLD) affiliated with a non-collocated AP MLD, a medium access control (MAC) request frame to associate a non-AP MLD with the non-collocated AP MLD, the MAC request frame to comprise an address field, wherein the address field comprises a receiver address (RA) that identifies the first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof; wherein the first AP MLD is a collocated AP MLD; and a means for determining that the MAC request frame is addressed to the non-collocated AP MLD based on the value. In Example 42, the apparatus of Example 41, further comprising a means for determining to accept the association after a determination that non-AP stations (STAs) of the non-AP MLD can operate on links with the AP STAs identified by the MAC request frame based on complete profiles of the non-AP STAs of the non-AP MLD in a multi-link element of the MAC request frame. In Example 43, the apparatus of Example 41, further comprising: a means for generating a MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD; and a means for causing transmission of the MAC response frame to the non-AP MLD. In Example 44, the apparatus of Example 43, further comprising a means for generating a new link ID for a link set up between a non-AP STA of the non-AP MLD and an AP STA of a second AP MLD affiliated with the non-collocated AP MLD. In Example 45, the apparatus of Example 44, further comprising a means for generating a mapping table entry for the new link ID, wherein the mapping table entry comprises a collocated AP MLD field and a non-collocated AP MLD field, the collocated AP MLD field comprising an identifier for the second AP MLD and a second link ID; the non-collocated AP MLD field comprising the new link ID. In Example 46, the apparatus of Example 44, further comprising a means for including the new link ID in a non-collocation link ID field of a STA control field of a link info field of the multi-link element of the MAC response frame. In Example 47, the apparatus of Example 41, wherein the MAC request frame comprises an association request frame, a reassociation request frame, or an authentication frame. In Example 48, the apparatus of Example 41, wherein the value to identify the non-collocated AP MLD is different from a MAC address of the first AP MLD or the value of an MLD ID for the first AP MLD. In Example 49, the apparatus of Example 41, further comprising using, for authentication, the same security keys for different groups of collocated AP STAs of a non-collocated AP MLD, wherein the different groups of collocated AP STAs are non-collocated. In Example 50, the apparatus of Example 41, further comprising using, for authentication, different security keys for different groups of collocated AP STAs of a non-collocated AP MLD, wherein the different groups of collocated AP STAs are non-collocated. In Example 51, the apparatus of Example 41, wherein the means for parsing comprises a means for parsing the MAC request frame to determine the value of the flag, wherein the value of the flag comprises one or more bits, the value to indicate whether the MAC frame is addressed to the non-collocated AP MLD or addressed to the first AP MLD, wherein the first AP MLD is a collocated AP MLD.

Example 52 is an apparatus comprising: a memory; and logic circuitry of a non-AP multilink device (MLD) coupled with the memory to: generate a medium access control (MAC) request frame, the MAC request frame to associate a non-AP MLD with the non-collocated AP MLD, the MAC request frame to comprise an address field, wherein the address field comprises a receiver address (RA) that identifies a first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof, wherein the first AP MLD is a collocated AP MLD; cause transmission of the MAC request frame to the first AP MLD. In Example 53, the apparatus of Example 52, wherein the logic circuitry comprises baseband processing circuitry and further comprising a radio coupled with the baseband processing circuitry, and one or more antennas coupled with the radio to transmit the MAC request frame. In Example 54, the apparatus of Example 52, wherein the MAC request frame comprises an association request frame or a reassociation request frame, the logic circuitry to further receive a MAC response frame to confirm or reject the association with the non-collated AP MLD, the MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD. In Example 55, the apparatus of Example 54, the MAC response frame comprises a new link ID in a non-collocation link ID field of a STA control field of a link info field of the multi-link element of the MAC response frame. In Example 56, the apparatus of Example 52, wherein the value to identify the non-collocated AP MLD is different from a MAC address of the first AP MLD or the value of an MLD ID for the first AP MLD. In Example 57, the apparatus of Example 52, the logic circuitry to use, for authentication, the same security keys for different groups of collocated AP STAs of a non-collocated AP MLD, wherein the different groups of collocated AP STAs are non-collocated. In Example 58, the apparatus of Example 52, the logic circuitry to use, for authentication, different security keys for different groups of collocated AP STAs of a non-collocated AP MLD, wherein the different groups of collocated AP STAs are non-collocated. In Example 59, the apparatus of Example 52, the logic circuitry to determine, for generation of the MAC request frame, the value of the flag, wherein the value of the flag comprises one or more bits, the value to indicate whether the MAC frame is addressed to the non-collocated AP MLD or addressed to the first AP MLD, wherein the first AP MLD is a collocated AP MLD. In Example 60, the apparatus of Example 52, the logic circuitry to determine, for generation of a frame header of the MAC request frame, the value for the non-collocated AP MLD ID, the value of the flag, or a combination thereof. In Example 61, the apparatus of Example 52, the logic circuitry to determine, for generation of a multi-link (ML) element in the frame body of the MAC request frame, the value for the non-collocated AP MLD ID, the value of the flag, or a combination thereof.

Example 62 is a non-transitory computer-readable medium, comprising instructions, which when executed by a processor, cause the processor to perform operations to: generate a medium access control (MAC) request frame, the MAC request frame to associate a non-AP MLD with the non-collocated AP MLD, the MAC request frame to comprise an address field, wherein the address field comprises a receiver address (RA) that identifies a first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof; wherein the first AP MLD is a collocated AP MLD; cause transmission of the MAC request frame to the first AP MLD. In Example 63, the non-transitory computer-readable medium of Example 62, wherein the MAC request frame comprises an association request frame or a reassociation request frame, the operations to further receive a MAC response frame to confirm or reject the association with the non-collated AP MLD, the MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD. In Example 64, the non-transitory computer-readable medium of Example 63, the MAC response frame comprises a new link ID in a non-collocation link ID field of a STA control field of a link info field of the multi-link element of the MAC response frame. In Example 65, the non-transitory computer-readable medium of Example 62, wherein the value to identify the non-collocated AP MLD is different from a MAC address of the first AP MLD or the value of an MLD ID for the first AP MLD. In Example 66, the non-transitory computer-readable medium of Example 62, the operations to use, for authentication, the same security keys for different groups of collocated AP STAs of a non-collocated AP MLD, wherein the different groups of collocated AP STAs are non-collocated. In Example 67, the non-transitory computer-readable medium of Example 62, the operations to use, for authentication, different security keys for different groups of collocated AP STAs of a non-collocated AP MLD, wherein the different groups of collocated AP STAs are non-collocated. In Example 68, the non-transitory computer-readable medium of Example 62, the operations to determine, for generation of the MAC request frame, the value of the flag, wherein the value of the flag comprises one or more bits, the value to indicate whether the MAC frame is addressed to the non-collocated AP MLD or addressed to the first AP MLD, wherein the first AP MLD is a collocated AP MLD. In Example 69, the non-transitory computer-readable medium of Example 62, the operations to determine, for generation of a frame header of the MAC request frame, the value for the non-collocated AP MLD ID, the value of the flag, or a combination thereof. In Example 70, the non-transitory computer-readable medium of Example 62, the operations to determine, for generation of a multi-link (ML) element in the frame body of the MAC request frame, the value for the non-collocated AP MLD ID, the value of the flag, or a combination thereof.

Example 71 is a method comprising: generating medium access control (MAC) request frame, the MAC request frame to associate a non-AP MLD with the non-collocated AP MLD, the MAC request frame to comprise an address field, wherein the address field comprises a receiver address (RA) that identifies a first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof; wherein the first AP MLD is a collocated AP MLD; causing transmission of the MAC request frame to the first AP MLD. In Example 72, the method of Example 69, wherein the MAC request frame comprises an association request frame or a reassociation request frame, further comprising receiving a MAC response frame to confirm or reject the association with the non-collated AP MLD, the MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD. In Example 73, the method of Example 72, wherein the MAC response frame comprises a new link ID in a non-collocation link ID field of a STA control field of a link info field of the multi-link element of the MAC response frame. In Example 74, the method of Example 71, wherein the value to identify the non-collocated AP MLD is different from a MAC address of the first AP MLD or the value of an MLD ID for the first AP MLD. In Example 75, the method of Example 71, further comprising using, for authentication, the same security keys for different groups of collocated AP STAs of a non-collocated AP MLD, wherein the different groups of collocated AP STAs are non-collocated. In Example 76, the method of Example 71, using, for authentication, different security keys for different groups of collocated AP STAs of a non-collocated AP MLD, wherein the different groups of collocated AP STAs are non-collocated. In Example 77, the method of Example 71, further comprising determining, for generation of the MAC request frame, the value of the flag, wherein the value of the flag comprises one or more bits, the value to indicate whether the MAC frame is addressed to the non-collocated AP MLD or addressed to the first AP MLD, wherein the first AP MLD is a collocated AP MLD. In Example 78, the method of Example 71, further comprising determining, for generation of a frame header of the MAC request frame, the value for the non-collocated AP MLD ID, the value of the flag, or a combination thereof. In Example 79, the method of Example 71, further comprising determining, for generation of a multi-link (ML) element in the frame body of the MAC request frame, the value for the non-collocated AP MLD ID, the value of the flag, or a combination thereof.

Example 80 is an apparatus comprising: a means for generating a medium access control (MAC) request frame, the MAC request frame to associate a non-AP MLD with the non-collocated AP MLD, the MAC request frame to comprise an address field, wherein the address field comprises a receiver address (RA) that identifies a first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof, wherein the first AP MLD is a collocated AP MLD; a means for causing transmission of the MAC request frame to the first AP MLD. In Example 81, the apparatus of Example 80, wherein the MAC request frame comprises an association request frame or a reassociation request frame, further comprising receiving a MAC response frame to confirm or reject the association with the non-collated AP MLD, the MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD. In Example 82, the apparatus of Example 81, wherein the MAC response frame comprises a new link ID in a non-collocation link ID field of a STA control field of a link info field of the multi-link element of the MAC response frame. In Example 83, the apparatus of Example 80, wherein the value to identify the non-collocated AP MLD is different from a MAC address of the first AP MLD or the value of an MLD ID for the first AP MLD. In Example 84, the apparatus of Example 80, further comprising a means for using, for authentication, the same security keys for different groups of collocated AP STAs of a non-collocated AP MLD, wherein the different groups of collocated AP STAs are non-collocated. In Example 85, the apparatus of Example 80, further comprising a means for using, for authentication, different security keys for different groups of collocated AP STAs of a non-collocated AP MLD, wherein the different groups of collocated AP STAs are non-collocated. In Example 86, the apparatus of Example 80, further comprising a means for determining, for generation of the MAC request frame, the value of the flag, wherein the value of the flag comprises one or more bits, the value to indicate whether the MAC frame is addressed to the non-collocated AP MLD or addressed to the first AP MLD, wherein the first AP MLD is a collocated AP MLD. In Example 87, the apparatus of Example 80, further comprising a means for determining, for generation of a frame header of the MAC request frame, the value for the non-collocated AP MLD ID, the value of the flag, or a combination thereof. In Example 88, the apparatus of Example 80, further comprising a means for determining, for generation of a multi-link (ML) element in the frame body of the MAC request frame, the value for the non-collocated AP MLD ID, the value of the flag, or a combination thereof.

What is claimed is:

1. An apparatus comprising:
a memory; and
logic circuitry of a first access point (AP) multilink device (MLD) affiliated with a non-collocated AP MLD coupled with the memory to:
parse a medium access control (MAC) request frame to associate a non-AP MLD with the non-collocated AP MLD, the MAC request frame to comprise an address field, wherein the address field comprises a receiver address (RA) that identifies the first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof, wherein the first AP MLD is a collocated AP MLD; and
determine that the MAC request frame is addressed to the non-collocated AP MLD based on the value.

2. The apparatus of claim 1, the logic circuitry comprising further to determine to accept the association after a determination that non-AP stations (STAs) of the non-AP MLD can operate on links with the AP STAs identified by the MAC request frame based on complete profiles of the non-AP STAs of the non-AP MLD in a multi-link element of the MAC request frame.

3. The apparatus of claim 1, the logic circuitry to further:
generate a MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD; and
cause transmission of the MAC response frame to the non-AP MLD.

4. The apparatus of claim 3, the logic circuitry to generate a new link ID for a link set up between a non-AP STA of the non-AP MLD and an AP STA of a second AP MLD affiliated with the non-collocated AP MLD.

5. The apparatus of claim 4, the logic circuitry to generate a mapping table entry for the new link ID, wherein the mapping table entry comprises a collocated AP MLD field and a non-collocated AP MLD field, the collocated AP MLD field comprising an identifier for the second AP MLD and a second link ID; the non-collocated AP MLD field comprising the new link ID.

6. The apparatus of claim 4, the logic circuitry to include the new link ID in a non-collocation link ID field of a STA control field of a link info field of the multi-link element of the MAC response frame.

7. The apparatus of claim 1, the logic circuitry comprising baseband processing circuitry and further comprising a radio coupled with the baseband processing circuitry, and one or more antennas coupled with the radio to receive the MAC request frame.

8. The apparatus of claim 1, wherein the MAC request frame comprises an association request frame, a reassociation request frame, or an authentication frame.

9. The apparatus of claim 1, wherein the value to identify the non-collocated AP MLD is different from a MAC address of the first AP MLD or the value of an MLD ID for the first AP MLD.

10. The apparatus of claim 1, the logic circuitry to use, for authentication, the same security keys for different groups of collocated AP STAs of a non-collocated AP MLD, wherein the different groups of collocated AP STAs are non-collocated.

11. A non-transitory computer-readable medium, comprising instructions, which when executed by a processor, cause the processor to perform operations to:
parse a medium access control (MAC) request frame to associate a non-AP MLD with the non-collocated AP MLD, the MAC request frame to comprise an address field, wherein the address field comprises a receiver address (RA) that identifies the first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof, wherein the first AP MLD is a collocated AP MLD; and
determine that the MAC request frame is addressed to the non-collocated AP MLD based on the value.

12. The non-transitory computer-readable medium of claim 11, the logic circuitry comprising further to determine to accept the association after a determination that non-AP stations (STAs) of the non-AP MLD can operate on links with the AP STAs identified by the MAC request frame based on complete profiles of the non-AP STAs of the non-AP MLD in a multi-link element of the MAC request frame.

13. The non-transitory computer-readable medium of claim 11, the operations to further:
generate a MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD; and
cause transmission of the MAC response frame to the non-AP MLD.

14. The non-transitory computer-readable medium of claim 14, the logic circuitry to generate a new link ID for a link set up between a non-AP STA of the non-AP MLD and an AP STA of a second AP MLD affiliated with the non-collocated AP MLD.

15. The non-transitory computer-readable medium of claim 15, the logic circuitry to generate a mapping table entry for the new link ID, wherein the mapping table entry comprises a collocated AP MLD field and a non-collocated AP MLD field, the collocated AP MLD field comprising an identifier for the second AP MLD and a second link ID; the non-collocated AP MLD field comprising the new link ID.

16. The non-transitory computer-readable medium of claim 16, the logic circuitry to include the new link ID in a non-collocation link ID field of a STA control field of a link info field of the multi-link element of the MAC response frame.

17. An apparatus comprising:
a memory; and
logic circuitry of a non-AP multilink device (MLD) coupled with the memory to:
generate a medium access control (MAC) request frame, the MAC request frame to associate a non-AP MLD with the non-collocated AP MLD, the MAC request frame to comprise an address field, wherein the address field comprises a receiver address (RA) that identifies a first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof, wherein the first AP MLD is a collocated AP MLD;
cause transmission of the MAC request frame to the first AP MLD.

18. The apparatus of claim 17, wherein the logic circuitry comprises baseband processing circuitry and further comprising a radio coupled with the baseband processing circuitry, and one or more antennas coupled with the radio to transmit the MAC request frame.

19. The apparatus of claim 17, wherein the MAC request frame comprises an association request frame or a reassociation request frame, the logic circuitry to further receive a MAC response frame to confirm or reject the association with the non-collated AP MLD, the MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD.

20. The apparatus of claim 19, the MAC response frame comprises a new link ID in a non-collocation link ID field of a STA control field of a link info field of the multi-link element of the MAC response frame.

21. The apparatus of claim 52, the logic circuitry to determine, for generation of a frame header of the MAC request frame, the value for the non-collocated AP MLD ID, the value of the flag, or a combination thereof.

22. A non-transitory computer-readable medium, comprising instructions, which when executed by a processor, cause the processor to perform operations to:
generate a medium access control (MAC) request frame, the MAC request frame to associate a non-AP MLD with the non-collocated AP MLD, the MAC request frame to comprise an address field, wherein the address field comprises a receiver address (RA) that identifies a first AP MLD, and a recipient field comprising a value, wherein the value comprises a MAC address to identify the non-collocated AP MLD, a MLD identifier (ID) of the non-collocated AP MLD, a flag to indicate whether the MAC frame is addressed to the non-collocated AP MLD or is addressed to the first AP MLD, or a combination thereof, wherein the first AP MLD is a collocated AP MLD;
cause transmission of the MAC request frame to the first AP MLD.

23. The non-transitory computer-readable medium of claim 22, wherein the MAC request frame comprises an association request frame or a reassociation request frame, the operations to further receive a MAC response frame to confirm or reject the association with the non-collated AP MLD, the MAC response frame comprising an address field, wherein the address field comprises a MAC address to identify the non-AP MLD, and a link ID field of per-STA profile subelements of a multi-link element of the MAC response frame, the link ID field comprising link IDs for links between non-AP STAs of the non-AP MLD and AP STAs affiliated with the non-collocated AP MLD.

24. The non-transitory computer-readable medium of claim 23, the MAC response frame comprises a new link ID in a non-collocation link ID field of a STA control field of a link info field of the multi-link element of the MAC response frame.

25. The non-transitory computer-readable medium of claim 22, the operations to determine, for generation of a multi-link (ML) element in the frame body of the MAC request frame, the value for the non-collocated AP MLD ID, the value of the flag, or a combination thereof.
